(19) United States
(12) Patent Application Publication
(10) Pub. No.: US 2006/0147163 A1
(43) Pub. Date: Jul. 6, 2006

(54) Optical fiber cable and blowing installation technique

(76) Inventors: Andrew J. Mayhew, Ipswich (GB); Nicholas J. Medlen, Ipswich (GB); Neil H. Rabone, Grundisburgh (GB); Simon C. Roberts, Tunbridge Wells (GB)

Correspondence Address: NIXON & VANDERHYE, PC, 901 NORTH GLEBE ROAD, 11TH FLOOR, ARLINGTON, VA, 22203, US

(21) Appl. No.: 10/547,482

(22) PCT Filed: Mar. 3, 2004
(86) PCT No.: PCT/GB04/00884

§ 371 Date: Aug. 30, 2005

(30) Foreign Application Priority Data
Mar. 7, 2003 (GB) 0305276.8
Mar. 13, 2003 (GB) 0305789.0

(51) Int. Cl. G02B 6/44

(52) U.S. Cl. 385/100

(57) ABSTRACT

This invention relates to an optical cable, in particular to an optical fibre having an axially extending glass strand for channelling light therealong, and a jacket layer disposed around the glass strand, the jacket layer having a textured outer surface for facilitating, under the influence of a fluid drag, the advancement of the optical cable along a conduit, wherein the glass strand in cross section to the axial direction has a width of less than 100 microns. The reduced width of the glass strand(s) in the cable will cause the cable to be less stiff, which will be particularly beneficially when installing the cable using a blowing technique.

The present invention relates to an optical cable and in particular but not exclusively to an optical cable to be installed using a fibre blowing technique.

The technique known as fibre blowing or cable blowing was first described in EP 108590. In the technique, an optical cable is installed in a pre-installed duct or conduit through the use of viscous drag forces which act on the surface of the cable within the duct, the viscous drag forces being generated by passing a gas down the duct in the direction of installation at a velocity significantly greater than the rate of advance of the cable. The viscous drag forces are generally supplemented with the mechanical pushing forces, as described in EP 108590 and EP 292037, which are applied, throughout the installation process, by motor-driven drive wheels or drive belts in what is known as a blowing head. The magnitude of the pushing force which can be used is normally determined by the stiffness (and hence buckle resistance) of the cable which is being installed. It is also known to provide an enlarged leading end portion on the cable, or a piston whose diameter is small compared to the bore of the duct, or a leaking shuttle (as described in EP445858). The additional installation forces can be and are routinely used even when the cable which is being installed has a diameter of a few millimetres or less.

Another technique, mentioned in EP 108590, to enhance the blowing process, is to provide a shaped or textured outer surface to the cable which is to be installed. In this way, it is possible to increase the viscous drag force experienced by a cable (compared to the force which would otherwise have been experienced by a comparable cable with a smooth and unpatterned outer sheath). This technique is used both with small cables (sometimes referred to as fibre units) which have diameters of 4 mm or less, as well as with larger cables with diameters of 10 mm or 20 mm or more (as well as with cables of sizes intermediate these two ranges).

In EP 345968, there is described a range of single-fibre units having an external coating which comprises a radiation-cured polymer containing particulate matter. The particulate matter is variously, PTFE particles, hollow glass microspheres, or hollow polymeric microspheres. The particulate matter, which preferably has an average particle size of less than 60 microns, is mixed in with the un-cured liquid polymer. The fibre to be coated, which may already have a tertiary buffer layer, is drawn through a bath containing the polymer/particulate mixture to give an outer coating having a thickness in the range 10-70 microns. The coating is then cured using UV radiation. However, we have found that the coating systems as described in EP 345968 are not suitable for use in sheathing multiple-fibre units. In particular, we have found that such coatings on multiple-fibre units tend to fail when the unit is bent.

We have found that, particularly with multiple-fibre units such as 4-fibre and 8-fibre units, the coating system described in EP 345968 for single-fibre units wherein particulate matter is mixed in with the outer coating polymer, produces fibre units which are prone to “fibre breakout”. As a fibre unit is progressively bent, and thus experiences a progressively smaller bend radius, a certain bend radius is reached at which irreversible damage to the sheathing occurs allowing the fibres to be exposed. This phenomenon is known as fibre-breakout. If the bend radius at which fibre-breakout occurs (the minimum bend radius) is so large that a fibre unit is likely to experience its minimum bend radius during normal handling of the fibre unit, the unit is practically not usable.

Some of the shortcomings of the fibre units described in EP 345968 were addressed in our patent EP-B 521710. In particular the very poor fibre-breakout performance of the units of EP345968 was improved by providing an inner layer or inner layer portion of resin coating which was substantially free from significant inclusions of particulate matter, and an outer layer or outer layer portion of resin coating which carried particulate additions which additions provided the desired increase in fluid drag and reduced friction with the installation duct.

The process and constructions which are taught by EP-B 521710 have been a significant commercial and practical successful. In excess of 50,000 km of fibre units of this type have been produced/installed since 1992.

Despite the much published down-turn in the world telecommunications business and despite the equally well published super abundance of installed optical fibre which is as yet unused (so-called “dark fibre”), there remains interest in installing yet more optical fibre, both within the trunk and access networks of Telcos and within buildings, campuses and industrial parts etc. Much of this demand would best be satisfied by the use of fibre units with larger fibre counts than those that have so far found to be practical with the construction techniques set out in EP 521710 (and see also EP 757022), that is, units with fibre counts of 4 or more. While it is possible to produce workable fibre units in this way with fibre counts of 4 or more, there are concerns about their durability and tolerance to bending.

One of the principle reasons for the limit to the size of such fibre units is once again fibre-breakouts. As the fibre count increases, so do the stresses which arise in the jacket as it tries to contain and constrain the fibres. With more fibres, the further the outer most fibres are from the neutral access of the unit and hence the greater the range of stress (and potentially strain) that the different fibres are exposed to. In addition, as the diameter of the fibre unit expands to accommodate all the fibres, so the greater the compressive and tensile strains to which the jacket material is expose when the unit is bent. So either more elastic resins must be used, with usually some trade off for strength, or the same resin will have to withstand the greater strain.

As indicated in EP 521710, there is already a need to balance many conflicting requirements of material performance in order to achieve acceptable optical and mechanical performance for the fibre unit, particularly if it is to be usable at a range of temperatures likely to be encountered when deployed externally. As the fibre count of the fibre unit increases, it becomes harder to achieve a satisfactory compromise.

Much research continues to be done by optical fibre and optical cable producers, often working in conjunction with polymer designers and producers, to increase the range of sizes and conditions within which a workable compromise can be achieved. Understandably, the primary focus of research is into new and improved resins and new and improved coating techniques

According to one aspect of the invention, there is provided an optical cable having an optical fibre with a glass strand for channelling light along the cable, and a jacket disposed around the glass strand, the jacket having a textured outer surface for facilitating, under the influence of a fluid drag, the advancement of the optical cable along a conduit, wherein the glass strand has a width of less than 100 microns.

Because the (or each) glass strand has a reduced width, the glass strand will be more flexible and a jacket material that is less strong and/or thinner can be used to form the outer jacket without unduly increasing the risk of fibre breakout occurring. In this way, by easing the desired constrains on the jacket, cables can be fabricated which can more easily be installed using blowing technique in ducts or conduits having tight bends, in part because the contribution to the cable stiffness due to the glass strand and the associated risk of fibre breakout is reduced, and in part because a jacket that is less stiff and/or thinner can be used, again without unduly increasing the risk of fibre-breakout.

Furthermore, the reduced width of the glass strand(s) in the cable can allow a cable to be made less stiff, which can be particularly beneficial when installing the cable using a blowing technique, since tight bends in a conduit will be less likely to cause a frictional resistance of sufficient magnitude to prevent the cable from advancing under the influence of the fluid drag.

The textured surface may be formed by grooves, ridges, projections, depressions or other irregularities in the surface level, which irregularities may be arranged randomly or in the form of a repeating pattern. In a preferred embodiment, the jacket has the form of a layer which includes a plurality of particles distributed about the layer. The particles may be distributed on the layer surface, or alternatively the particles may be buried within the layer so as to provide a textured outer surface thereto. However, the particles will preferably be distributed towards the outer surface, so that the likelihood of a particle providing a point of weakness at an interior interface of the layer is reduced. In one embodiment, at least some of the particle have a respective projecting portion which outwardly projects from the jacket material, the projecting portions each having a smooth contour to help reduce the friction which the jacket material alone would otherwise experience when placed in moving contact with an opposing surface, such as the interior surface of a conduit.

Further aspects of the invention are provided as specified in the appended claims.

The invention will now be further described, by way of example, with reference to the following drawings, in which:

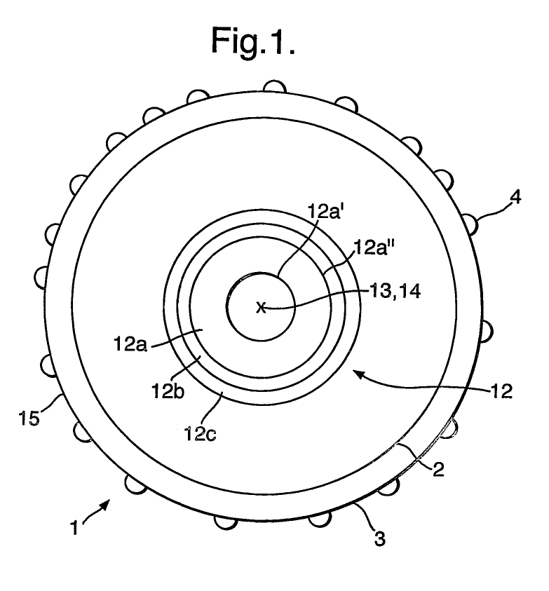

FIG. 1 is a schematic representation of a cross sectional view through an optical cable according to the invention;

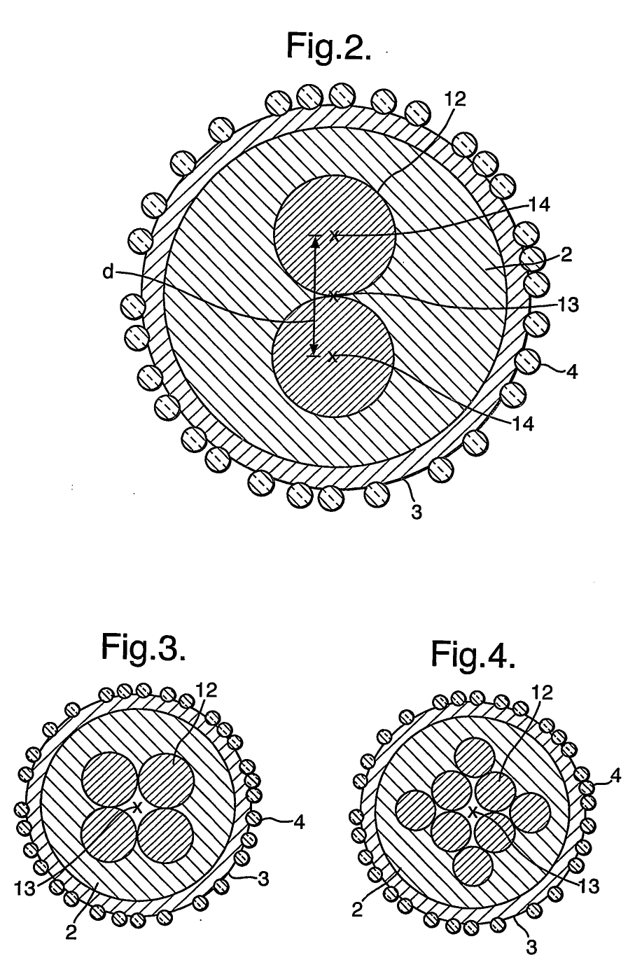

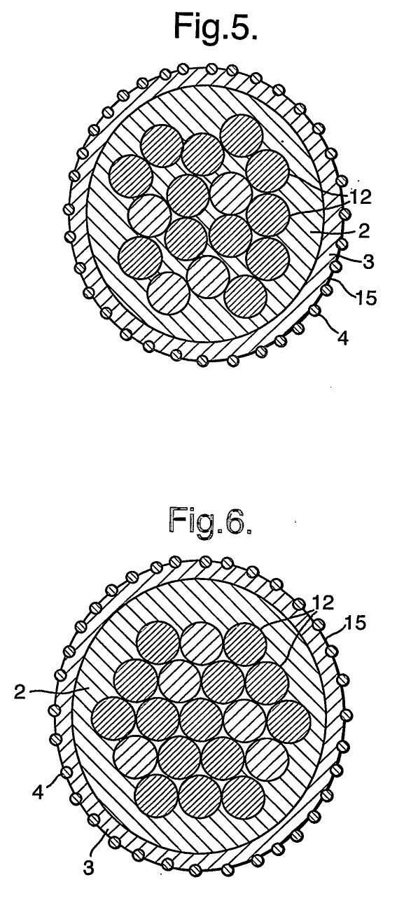

FIGS. 2-6 schematically illustrate further embodiments of an optical cable according to the invention;

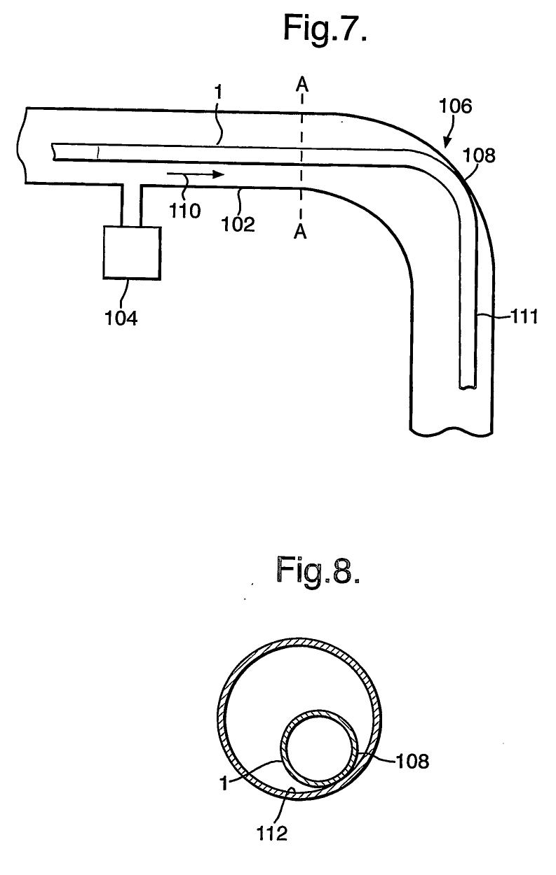

FIG. 7 shows a schematic plan view of conduit having an optical cable therein;

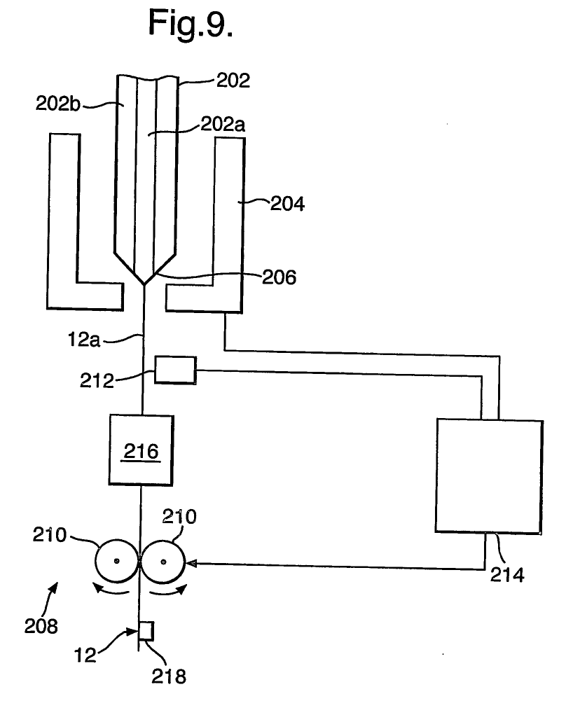

FIG. 8 shows a view through the section A-A of FIG. 7;

FIG. 9 shows apparatus for fabricating an optical fibre for use in a cable as shown in FIGS. 1-6; and,

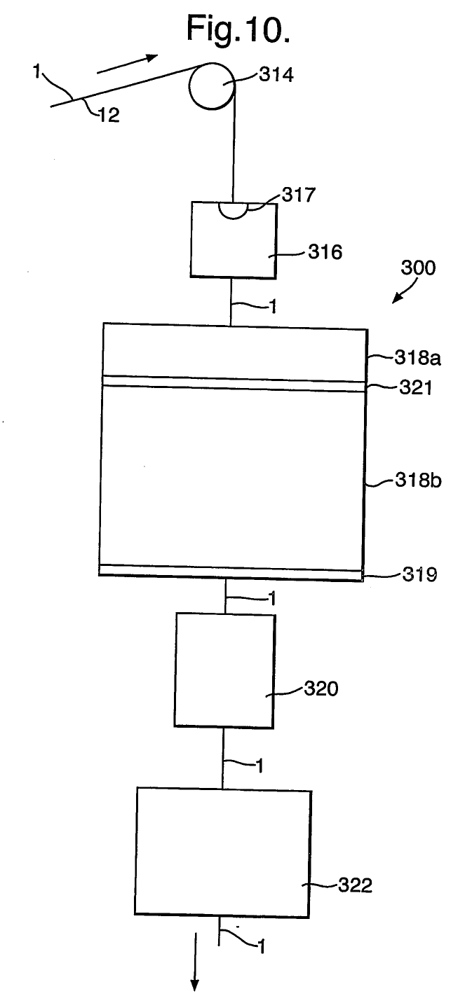

FIG. 10 shows schematically apparatus for fabricating a cable as shown in FIGS. 1-6 using one or more fibres produced with the apparatus of FIG. 9.

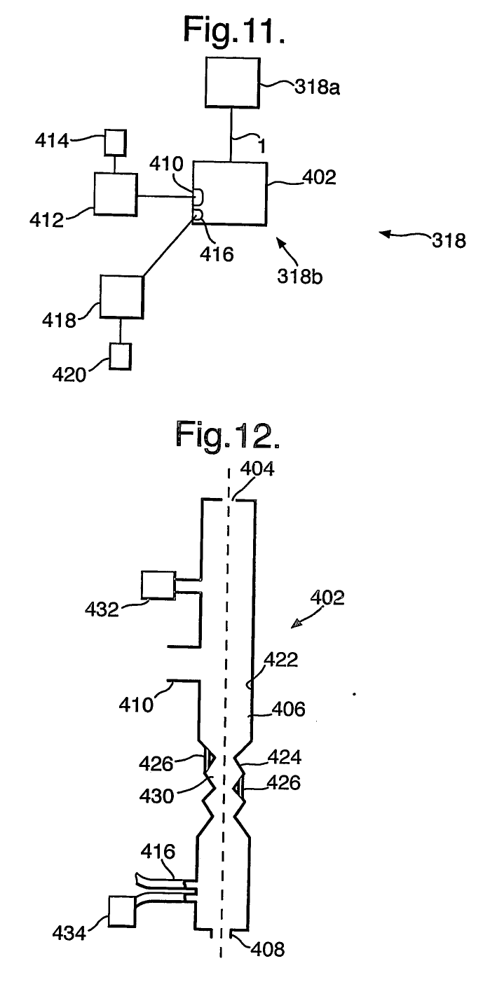

FIG. 11 shows in more detail coating apparatus of FIG. 10;

FIG. 12 illustrates apparatus for coating and optical cable with particles;

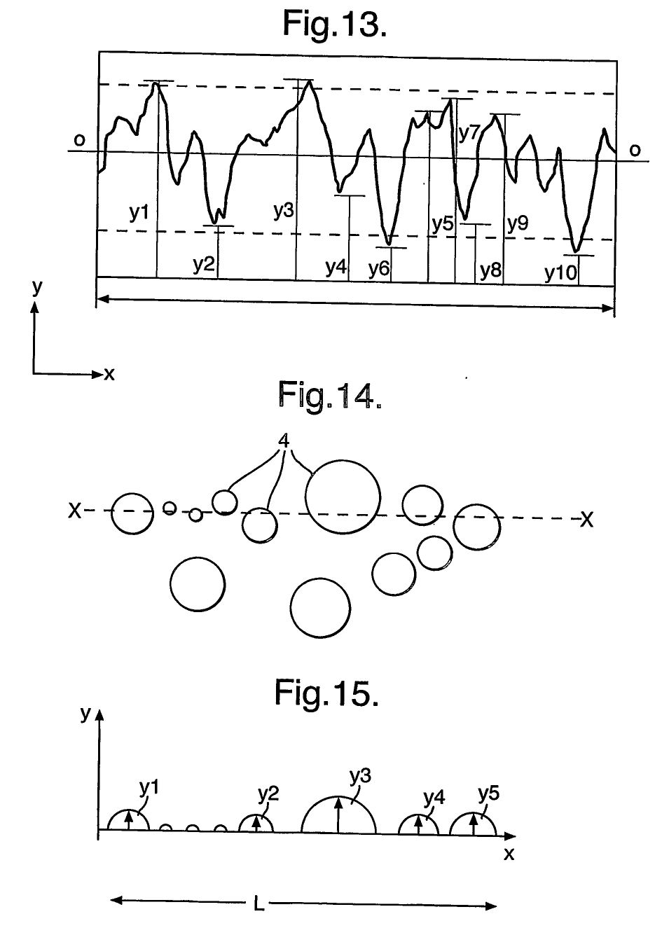

FIG. 13 shows how a roughness parameter can be obtained from an arbitrary profile;

FIG. 14 shows schematically a plan view of a portion of the outer surface of an optical cable;

FIG. 15 shows a cross sectional view through X-X of FIG. 14;

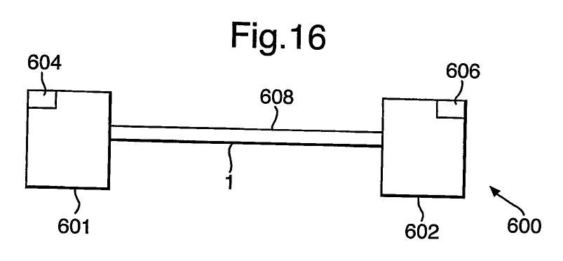

FIG. 16 shows schematically a telecommunications installation;

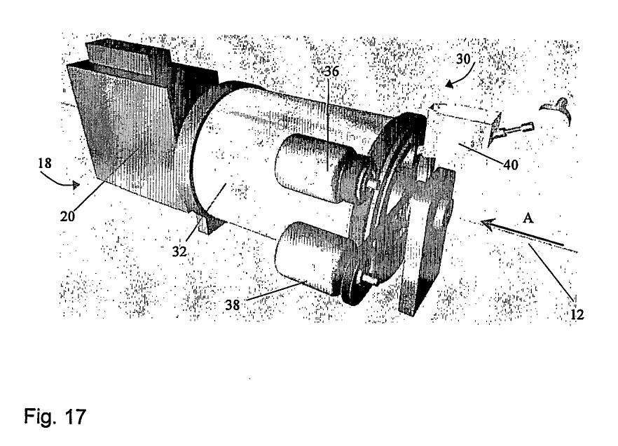

FIG. 17 is a perspective of a first alternative embodiment for applying particles to a cable;

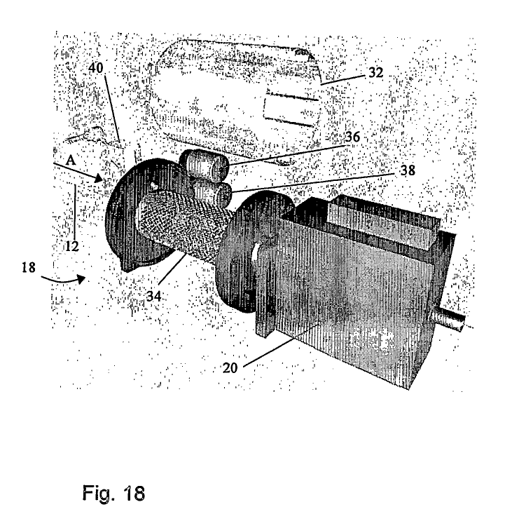

FIG. 18 is an exploded perspective of the first alternative embodiment;

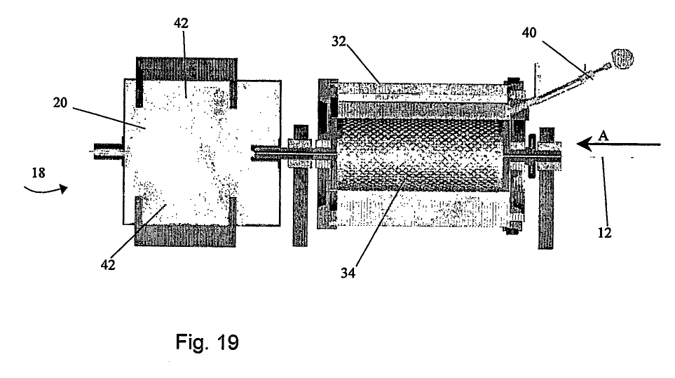

FIG. 19 is a cutaway side view of the first alternative embodiment;

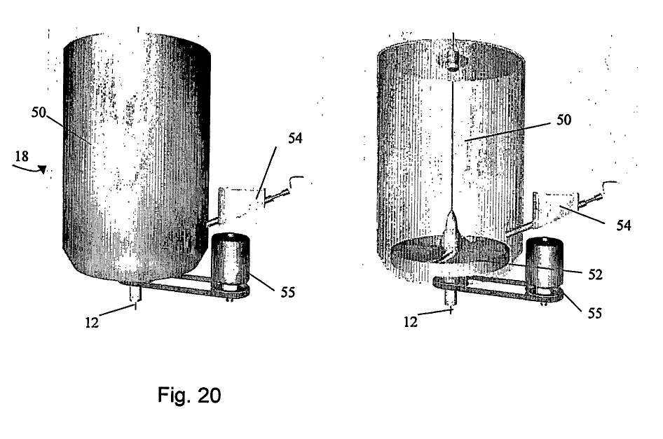

FIG. 20a is a perspective view of a second embodiment;

FIG. 20b is a perspective view of the second embodiment with the outer chamber transparent for clarity;

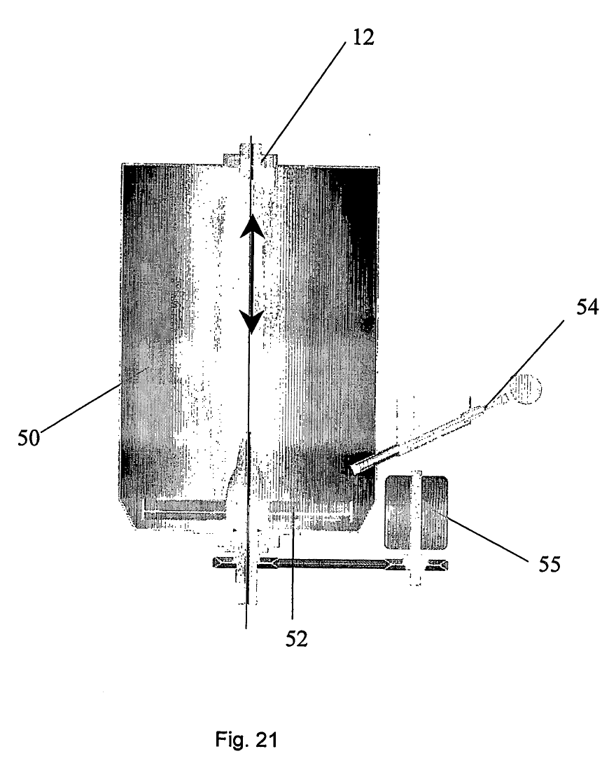

FIG. 21 is a cutaway side view of the second embodiment;

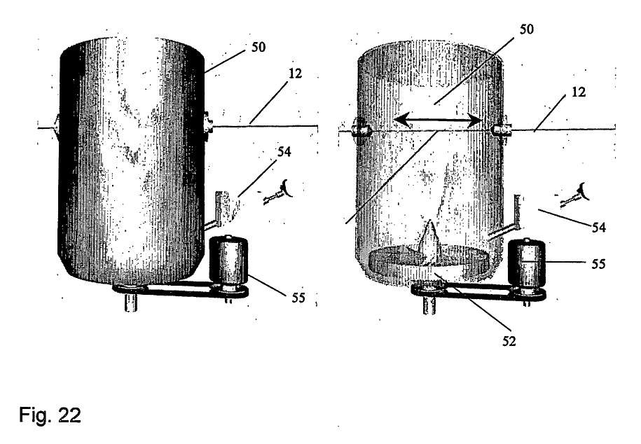

FIG. 22 is a perspective view of the second embodiment (variant);

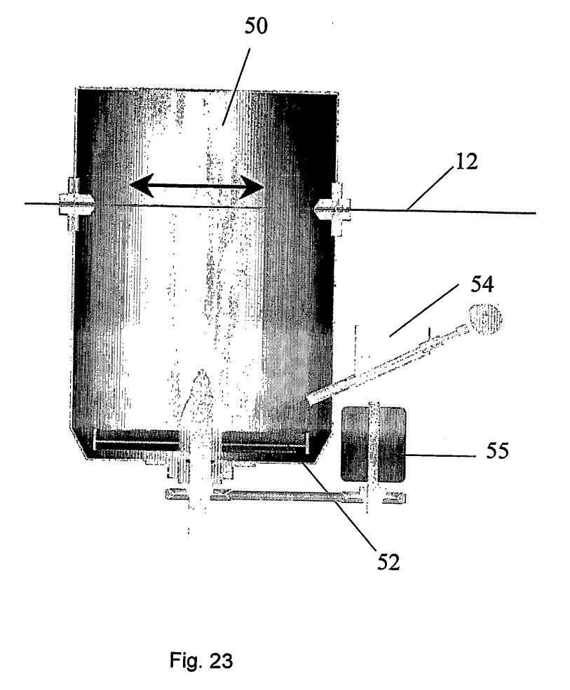

FIG. 23 is a cutaway side view of the second embodiment (variant);

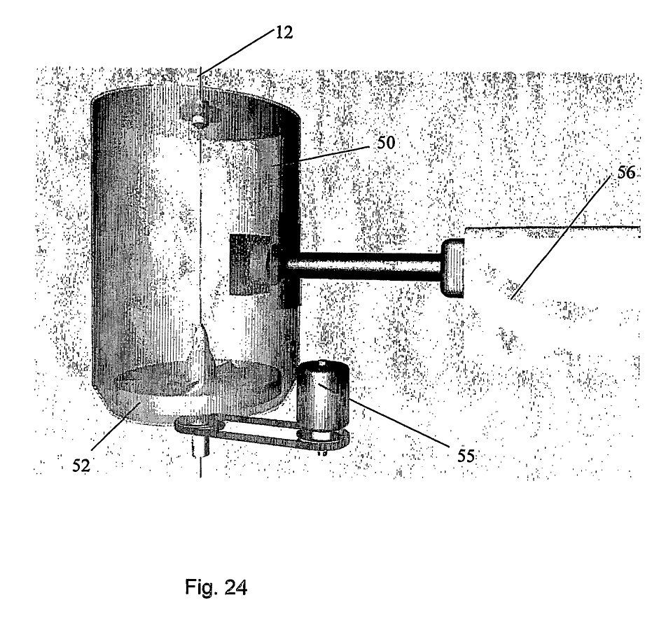

FIG. 24 is a perspective view of the second embodiment with the outer chamber transparent for clarity (further therein);

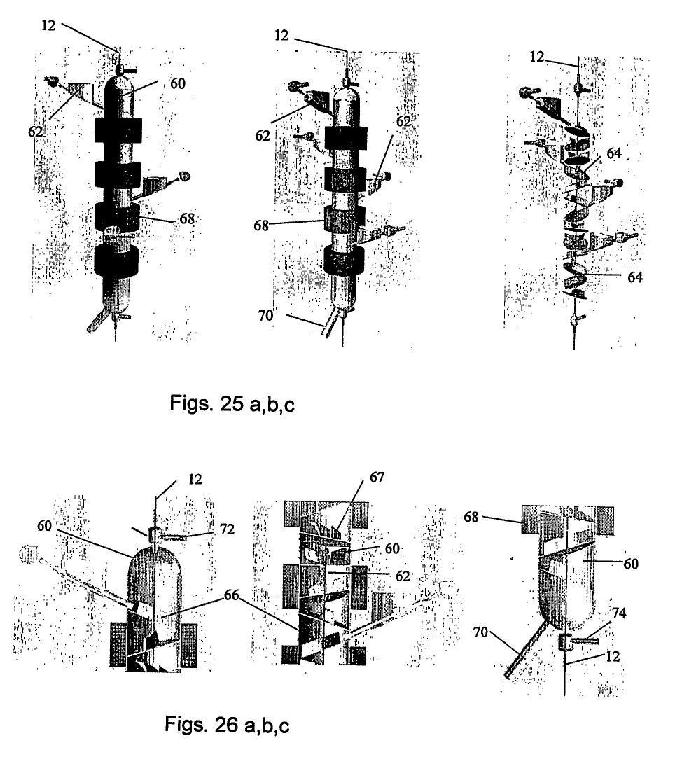

FIG. 25a is a first perspective view of the third embodiment;

FIG. 25b is a second perspective view of the third embodiment;

FIG. 25c is a third perspective view of the third embodiment with the outer chamber transparent for clarity;

FIG. 26a is a partial side view of the third embodiment showing the top section;

FIG. 26b is a partial side view of the third embodiment showing the middle section;

FIG. 26c is a partial side view of the third embodiment showing the bottom section;

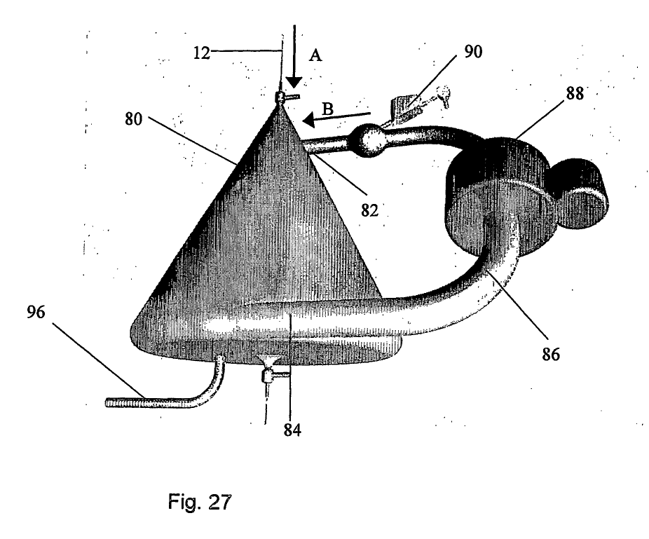

FIG. 27 is a perspective view of the fourth embodiment;

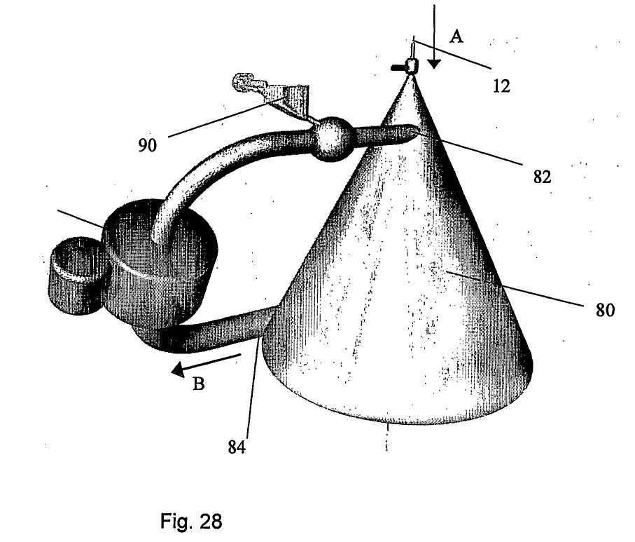

FIG. 28 is a further perspective view of the fourth embodiment;

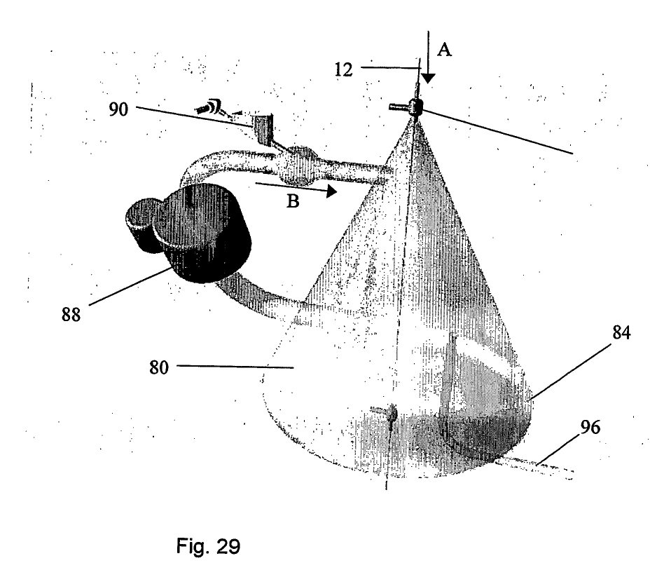

FIG. 29 is a further perspective view of the fourth embodiment with the outer chamber transparent for the purposes of clarity;

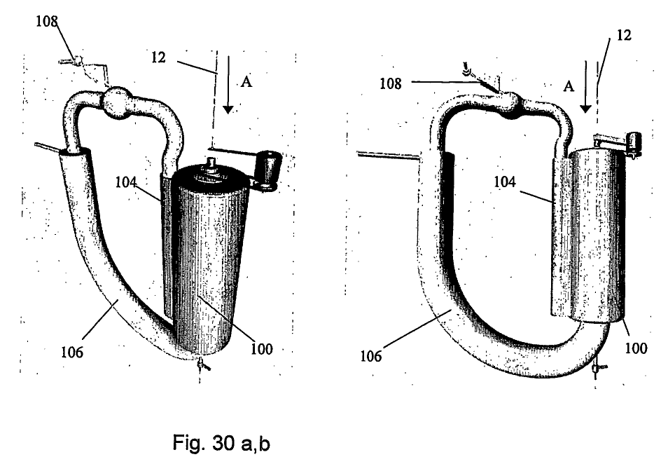

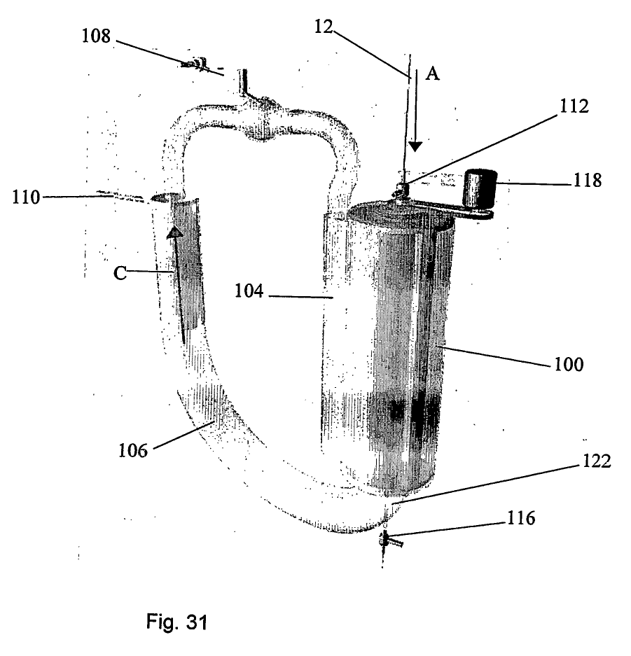

FIG. 30a is a perspective view of a fifth embodiment;

FIG. 30b is a further perspective view of the fifth embodiment;

FIG. 31 is a further perspective view of the fifth embodiment with the outer chamber and ducting shown transparent for clarity;

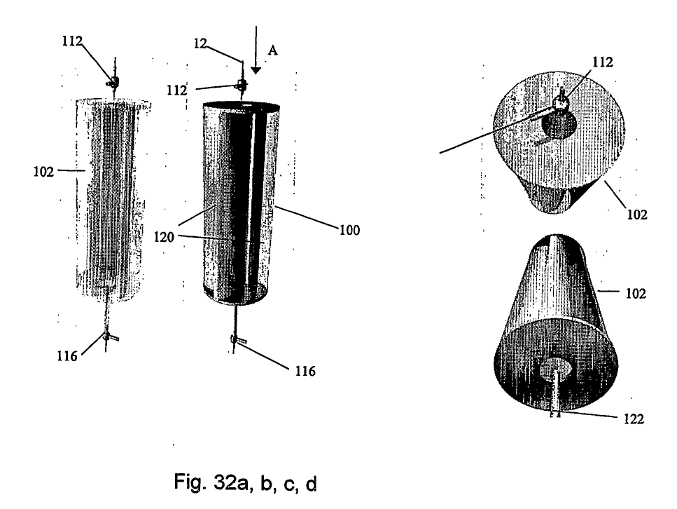

FIG. 32a is a perspective view of the vortex fan of the fifth embodiment;

FIG. 32b is a further perspective view of the vortex fan of the fifth embodiment;

FIG. 32c is a further perspective view of the vortex fan of the fifth embodiment;

FIG. 32d is a further perspective view of the vortex fan of the fifth embodiment;

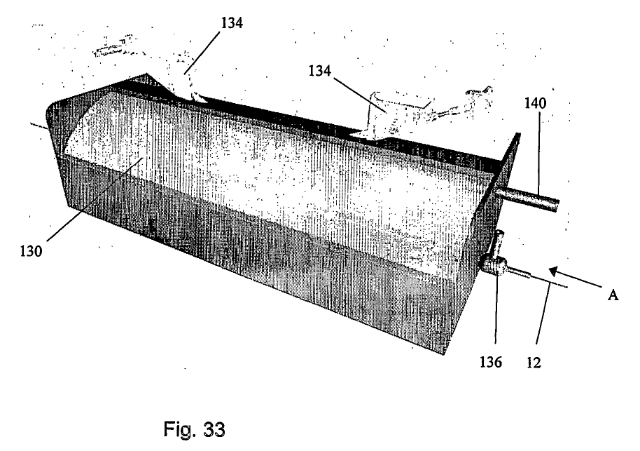

FIG. 33 is a perspective view of the sixth embodiment;

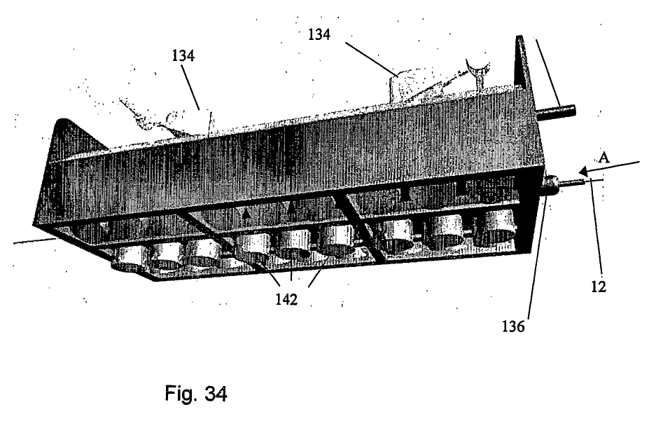

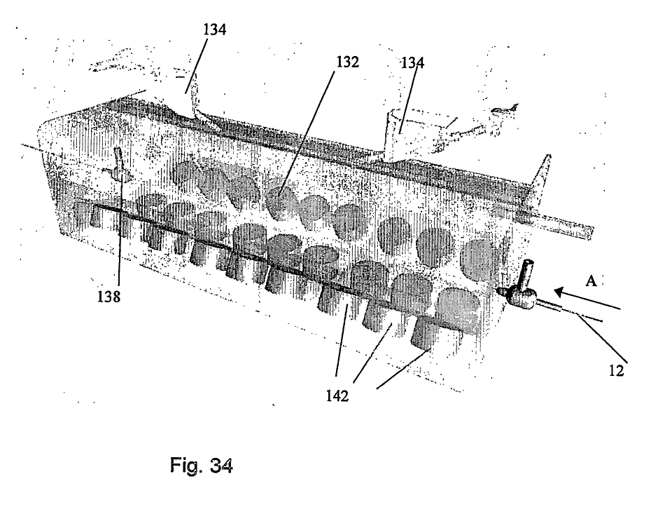

FIG. 34 is a further perspective view of the sixth embodiment;

FIG. 35 is a further perspective view of the sixth embodiment with the outer chamber transparent for clarity;

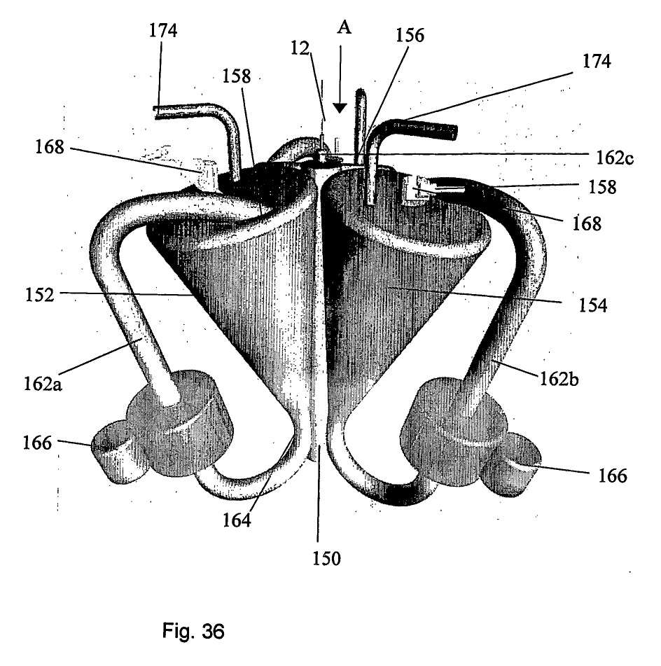

FIG. 36 is a perspective view of a seventh embodiment;

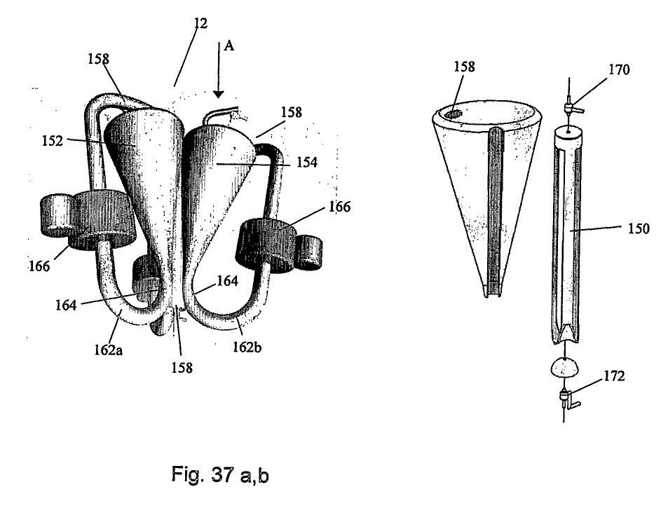

FIG. 37a is a further perspective view of the seventh embodiment;

FIG. 37b is a partial exploded perspective view of the seventh embodiment;

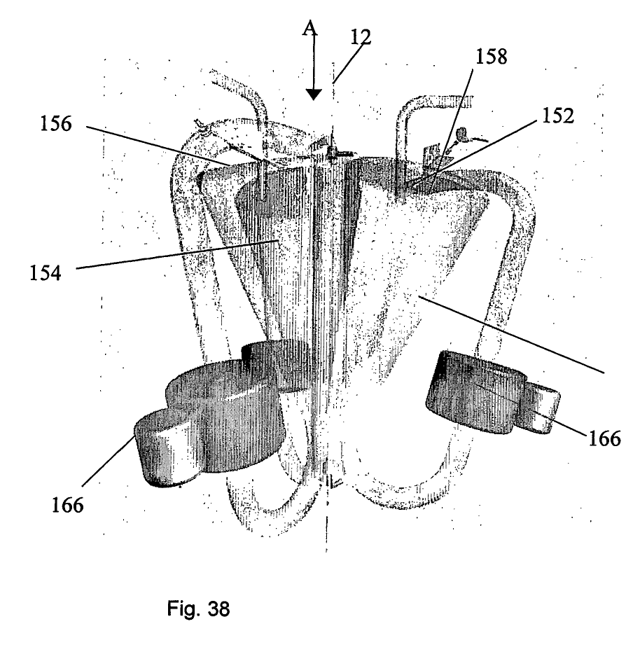

FIG. 38 is a perspective view of the seventh embodiment with the outer chamber shown transparent for clarity;

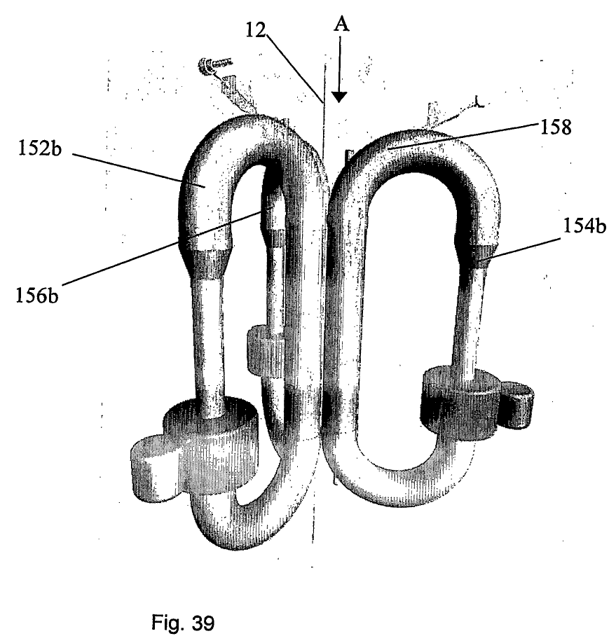

FIG. 39 is a perspective view of the seventh embodiment (variant);

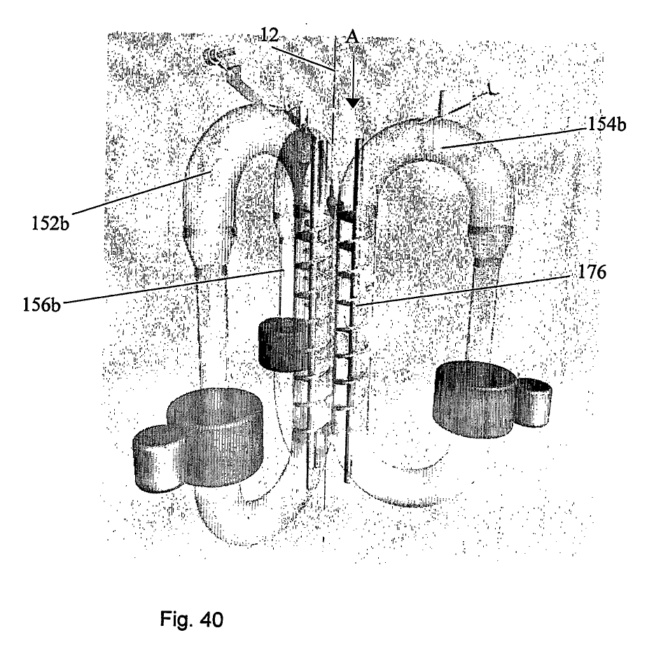

FIG. 40 is a perspective view of the seventh embodiment with the outer chamber shown transparent for clarity (variant);

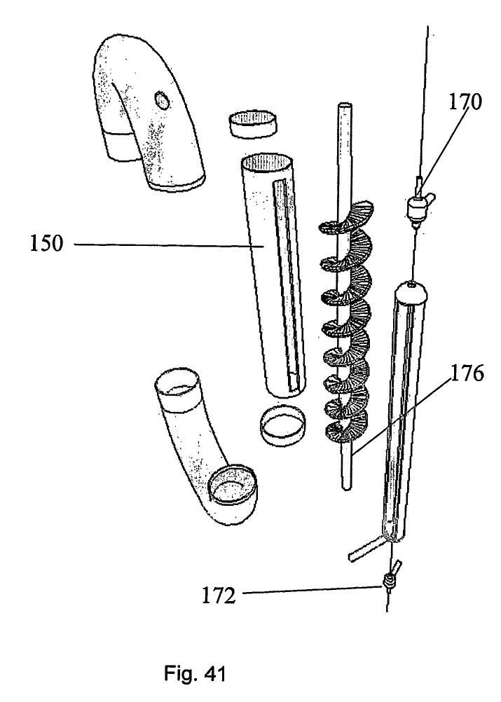

FIG. 41 is a partial exploded perspective view of the seventh embodiment (variant);

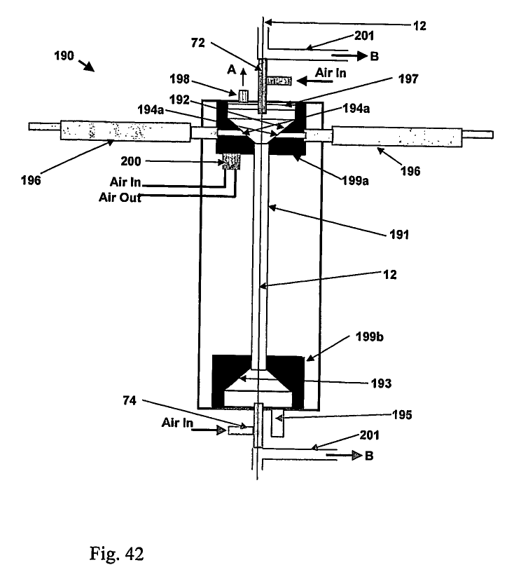

FIG. 42 is a block diagram of an eighth embodiment;

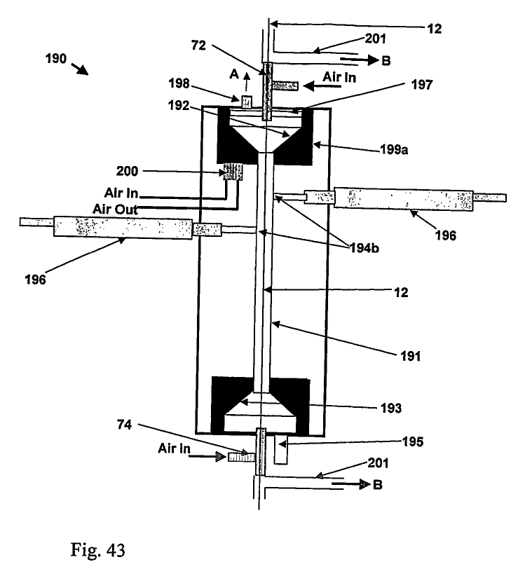

FIG. 43 is a block diagram of the eighth embodiment (variant); and

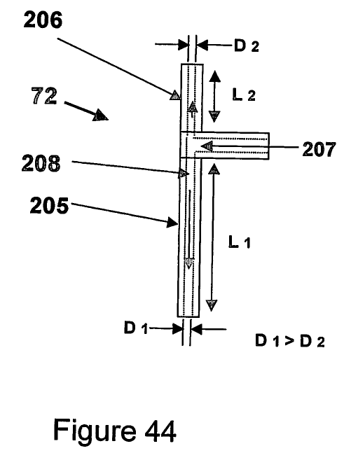

FIG. 44 is a block diagram of a positive pressure chamber for use in fibre coating apparatus.

In FIG. 1, there is shown a cross sectional view of an optical cable 1. The cable 1 has an optical fibre 12 extending along the cable axis 13, the fibre 12 being located within an outer sleeve or jacket 3. A buffer region 2 of buffer material is provided between the optical fibre 12 and the outer jacket 3, the buffer material being of a lower elastic modulus than that of the jacket material 3.

The optical fibre 12 has a glass region 12a for carrying light, and a protective region 12b, 12c extending around the glass region 12a to protect the glass from scratches or other damage. The glass region 12a is generally circular in cross section, extending in the axial direction of the fibre 12 in the form of a strand 12a. The strand 12a, formed from silica glass, includes a central core region 12a′ and a surrounding cladding region 12a″, the cladding region having a lower refractive index than the core region so that light can be contained within the core 12a′. Either or both of the core and cladding regions may be formed of a plurality of concentric regions of glass whose respective refractive indices are tailored for a chosen mode of light propagation.

The strand 12a has a width or diameter which is less than 100 microns, preferably less than about 80 microns, yet more preferably less than 60 microns, but preferably above 30 microns as below this width it will be difficult to reliably form fibres that are sufficiently long to be efficiently employed in network applications (often, a fibre to be installed will be at least 10 m in length, and will normally be unrolled from a drum having an initial length of fibre of at least 100 m: more usually the installed length will be in excess of 100 m, often in excess of 1 km and the production length will normally be several kilometres). In the present example, the glass strand is 80 microns in diameter and the protective region has a thickness which is generally about 10-15 microns, with the result that the width or diameter of the fibre is about 100 microns.

It will be appreciated that after the fabrication of a cable is complete, the glass strand(s) may not be perfectly circular in cross section, and can be generally elliptical or have an irregular boundary. However, such a strand will have an effective width or diameter corresponding to the diameter of a circular cross section of the same area.

The protective region 12b, 12c is formed by a primary coating 12b immediately surrounding the glass region 12a, and a secondary coating 12c extending around the primary coating 12b. The primary coating is formed from a material having a low elastic modulus, such as a silicone or an acrylate polymer, so as to act as a buffer or cushion between the glass strand 12a and the secondary coating 12c, which is formed from a hard material. In this way, the glass region 12a is bounded by a non-glass region 12b,c which at least in part surrounds the glass region.

The jacket layer 3 has a plurality of particles 4 distributed over the surface thereof, so as to provide the jacket layer 3 with an uneven or otherwise textured outer surface. To secure the particles 4 to the jacket 3, the particles are at least partially embedded within the material of the jacket 3, each partially embedded particle 4 projecting outwardly from the jacket 3. The particles 4 preferably have a smooth shape, such as a spherical-like or droplet shape, to reduce the risk that the projecting portions of the respective particles will increase the amount of friction the outer jacket surface would otherwise experience when brought into moving contact with a smooth opposing surface, such as the interior surface of a conduit. With an appropriate choice of material for the particles, for example the use of a hard material, such as glass, the amount of friction will be reduced. Such a reduction in friction is believed to result at least in part from the separation between the surface of the actual jacket material and the opposing surface. An additional effect brought about by the particles 4 is that the resulting textured surface will be more susceptible to fluid drag, such that for a given fluid flow which passes by the outer jacket surface, the distributed drag on the jacket surface will be increased (compared to that which would be experienced by a completely untextured surface).

A cable 1 with a textured outer surface 15 can more easily be installed using a blowing technique as illustrated in FIG. 7. Here, a cable 1 has been partially introduced into a tubular conduit 102, such that a leading portion 111 of the cable 1 is within the conduit or duct 102. The cable is inserted into the duct through the use of a pushing device (generally known as a blowing head). To advance the cable into the conduit in the travel direction 110, a flow of gas or other fluid such as air is passed through at least a portion of the conduit, using a compressor or supply of bottled gas 104 in fluid communication with the conduit. The fluid is conveniently applied to the duct or conduit via the blowing head. In such an installation technique, the drag between the fluid flow 110 and the cable 1 (in conjunction with the pushing force applied to the blowing head) causes the cable to move in the direction of the fluid flow. Because the cable is advanced at least in part due to the fluid forces, and because these fluid forces are distributed along the cable, rather than being present only at one end, the cable is less likely to be damaged during installation.

Because of the reduced diameter of the glass strand 12a compared to conventional communications optical fibres, the fibre 12 will be able to withstand bending to a smaller radius of curvature without causing a breach of the buffer or jacket layers (known as fibre breakout). This will reduce the thickness of the buffer or jacket material required. As a result of these considerations, in particular the reduced width of the glass strand which is important in itself in controlling the fibre stiffness, the cable can be made less stiff than a comparable cable using conventional communications fibres. The reduced stiffness can be important for cables having a textured surface 15 for installation using a blowing technique, because the reduced stiffness will reduce the forces the cable 1 exerts on the surface of a duct when the cable 1 bears against the duct in the vicinity of a bend. This can be seen more clearly in FIGS. 7 and 8, where in the vicinity of the bend 106 in the conduit, the curvature of the cable 1 in the travel direction is less than that of the conduit sidewall region 108, resulting in a frictional force which has to be overcome by the drag forces of the fluid flow 110. Since the frictional force exerted by the side wall 108 in the vicinity of a bend 106 is in part due to the stiffness of the cable 1, reducing the cable stiffness by reducing the diameter of the glass strand 12 may make it easier to advance the cable along the conduit. This benefit has to be balanced against the fact that the maximum pushing force which can be used is, at least in part, dictated by the stiffness of the cable used. Use of a less stiff cable can therefore lead to the use of lower pushing forces and these may not be compensated for by reduced frictional forces. In particular, where the installation path is generally straight with no significant bends, it may be desirable to use stiffer rather less stiff cables, as these may permit the use of higher pushing forces. (Of course one can still use smaller diameter fibres in such higher stiffness cables). It will be appreciated that the reduced diameter of the glass strand 12a can also lead to a reduction in the weight of the cable 1, which may in turn reduce the friction caused by the weight of the cable 1 bearing down on a lower surface 112 of the duct under the influence of gravity. Thus, the reduced glass strand diameter and the resulting reduction in friction may make it possible to use the blowing technique to install cables in longer ducts and/or in ducts having tighter bends.

A cable 1 can be formed having a plurality of fibres 12, as indicated in FIGS. 2-6, where cables having 2, 4, 8, 16 and 19 fibres are shown respectively (components corresponding to those of FIG. 1 are given the same reference numerals). Each fibre 12 has a protective region 12b, 12c extending circumferentially around each respective fibre glass strand 12a, the protective region of each fibre being formed by primary and secondary coatings 12a, 12b (not shown). The fibres 12 are grouped towards the central axis 13 of the cable, a buffer region 2 being provided between the centrally grouped fibres 12 and the outer jacket 3. The aforementioned potential advantages of lower weight and reduced stiffness will be more pronounced with cables having a plurality of fibres, the relative contribution of the fibres 12 to the weight and stiffness generally being greater for cables having a higher number of fibres 12. The fibres will generally be arranged in a side-to-side relationship along the cable. The fibres may be arranged parallel to one another in the axial direction of the cable. Alternatively, some or all of the fibres may follow a helical or serpentine path relative to the cable axis.

In order to permit an increase in the fibre count of a cable of a given cross sectional area and/or to permit a further reduction in the cable stiffness, and/or in order to permit a reduction in the cross sectional area of a cable 1, the protective region 12b, 12c of each fibre 12 has a width of about 10 microns, so that the diameter of the or each fibre is less or equal to about 100 microns (the glass strand having a width of 80 microns). This allows the fibres 12 to be arranged such that the distance d between the central axis 14 of a fibre 12 and that of the nearest neighbouring fibre is equal to or less than about 100 microns. With such an arrangement, cables with an increased number of fibres 12 can be laid in an existing duct, without having to enlarge the cross sectional area of the duct. For example, the diameter of the cable shown in FIG. 3 having four fibres will be about 650 microns, as compared to about 1 millimetre for prior art fibres. The diameters of the 16 and 19 optical cables will be about 1 millimetre, whereas corresponding cables with existing fibres would have diameters of about 2 millimetre. Preferably, the diameter of each glass strand 12a will be sufficiently small and the protective region 12b, 12c will be sufficiently thin for the separation between the axis of nearest neighbouring fibres 12 to be less than 100 microns, preferably less than 80 microns, or even 60 microns, and possibly as low as 50 microns.

Because the strands will be more closely grouped towards the central cable axis, for a bend having a given radius of curvature, the fibres in the cable located towards the outer side of the cable at the bend will experience a lower level of tensile strain, whereas fibres located towards the inner side of cable at the bend will experience a lower level of compressive strain. This will reduce the likelihood of fibres becoming damaged (or fibre breakout occurring) as a result of a bend in the cable, or, equivalently, it will allow cables having a large number of fibres to be installed in a duct having a tighter bend.

In the examples of FIGS. 1-6, the particles 4 are in the form of glass beads which are preferably solid but may be hollow (such as Q-CEL 500 beads from PQ corporation) to reduce the weight of the cable. The glass beads on a cable may have a range of sizes, generally between 10 microns and 180 microns, the average outer diameter of the beads being about 68 microns, at least 80% of the beads having an outer diameter of more than 10 microns. Thus, the radial projections from the jacket material 3 may range from about 5 microns to about 100 microns in the radial direction with respect to the cable axis 14. However, preferably, the beads which are solid have a mean diameter of 128 microns and at least 80% of the beads have a diameter between 85 and 175 microns (eg 5-4 Spheriglass A Grade 2227 CPOO from Potters Industries Inc.).

The extent of the surface texture may be described in terms of a roughness parameter, which with respect to FIG. 13, is determined by the difference in height between the five highest peaks and the five lowest troughs over a given distance L, such that RZ=[(y1+y3+y5+y7+y9)−(y2−y4−y6−y8−y10)]÷5. Thus RZ is effectively a measure of the extent of the surface roughness, RZ being a parameter designated in British Standard BS1134 and ISO/R468. (It will be appreciated that the structure shown in FIG. 13 will not normally be responsible for the surface texture of the external surface of a cable).

FIG. 14 shows a plan view of a cable surface, the surface of the jacket layer having a plurality of beads 4 projecting from the jacket layer. To measure RZ, a height probe may be drawn along the line X-X of FIG. 14 in the axial direction of the cable, such that the resulting RZ value is given by the average height of the five highest protrusions, the troughs being of equal level. Preferably, to provide a good drag and a good reduction in surface friction, the centres of the glass spheres 4 will be about 200 microns apart in the axial direction of the cable (such that the spacing between the projecting portions at the level of the surface of the jacket material is on average about 50-100 microns) and the (average) RZ value in that direction over a measuring distance L of 2.5 mm will be greater than 60 microns. However, the separation between the centres of the spheres may be about 350 microns or 250 microns.

The buffer region 2 can be formed from silicone acrylate material such as Cablelite 950-701 (DSM Desotech), whereas the jacket material, normally about 50 microns thick and of higher elastic modulus than the buffer layer 2, can be formed from urethane acrylate such as Cablelite 950-705. However, the buffer region 2 is preferably formed from Cablelite 3287-9-39A (DSM Desotech), and the jacket from Cablelite 3287-9-75, each a curable matrix material. The Secant modulus (stress/strain) at 2.5% strain for the buffer and jacket materials is preferably about 1 MPa and 730 MPa respectively at a temperature of 23 degrees Celsius (after curing), although values within +/−20% of each respective value may be acceptable. The tensile strength of the buffer and jacket materials will preferably be about 1.3 MPa and 30 MPa respectively, at a temperature of 23 degrees Celsius (after curing). The characteristics of Cablelite 3287-9-39A and Cablelite 3287-9-75 are listed in Tables 1 and 2 respectively.

TABLE 1
Characteristics

| | Typical |
|---|---|
| | Properties |
| Liquid Coating | |
| Viscosity at 25° C., mPa · s | 10500 |
| Density at 23° C., kg · m⁻³ | 1080 |
| Cured Coating* | |
| Tested at <1% R.H. | |
| Dynamic Mechanical Analysis (see DMA graph) | |
| Glass Transition Range (DMA), ° C. at | |
| E′ _{1000 MPa} | −57 |
| E′ _{100 MPa} | −34 |
| Tested at 23° C., 50% R.H. | |
| Physical Properties | |
| Secant modulus, 2.5% strain, MPa | 1.0 |
| Elongation, % | 135 |
| Tensile strength, MPa | 1.3 |
| Degree of Cure | |
| UV Dose of 95% at Ultimate Secant Modulus, J · cm⁻² | 0.5 |
| Dynamic Water Sensitivity, 250 μm films, | |
| Peak absorption, % | 1.5 |
| Extractables, % | 1.6 |
| Hydrogen Generation (24 hrs. at 80° C. in Argon), μl · g⁻¹ | 0.6 |

*75 μm films cured in nitrogen at 1.0 J · cm⁻² using one Fusion D lamp, unless stated otherwise. UV dose determined with an IL-390 Radiometer manufactured by International Light, Inc.

TABLE 2
Characteristics

| | Typical |
|---|---|
| | Properties |
| Liquid Coating | |
| Viscosity at 25° C., mPa · s | 9300 |
| Density at 23° C., kg · m⁻³ | 1100 |
| Cured Coating* | |
| Tested at <1% R.H. | |
| Dynamic Mechanical Analysis (see DMA graph) | |
| Glass Transition Range (DMA), ° C. at | |
| E′ _{1000 MPa} | 26 |
| E′ _{100 MPa} | 66 |
| Tested at 23° C. 50% R.H. | |
| Physical Properties | |
| Secant modulus, 2.5% strain, MPa | 730 |
| Elongation, % | 40 |
| Tensile strength, MPa | 30 |
| Degree of Cure | |
| UV Dose of 95% at Ultimate Secant Modulus, J · cm⁻² | 0.2 |
| Water Absorption after 24 hours, 250 μm films, % | 3.0 |
| Hydrogen Generation (24 hrs. at 80° C. in Argon), μl · g⁻¹ | 0.6 |

*75 μm films cured in nitrogen at 1.0 J · cm⁻² using one Fusion D lamp, unless stated otherwise. UV dose determined with an IL-390 Radiometer manufactured by International Light, Inc.

It will be appreciated that the choice of materials for the buffer region 2 and the jacket 3 will depend at least in part upon the number of fibres 12 located within the jacket 3. Generally, the higher the number of fibres, the thicker the respective buffer region and jacket will be, and the higher will be their respective elastic modulus.

FIG. 9 shows schematically apparatus for fabricating a fibre 12 having a reduced width. The fibre 12 is drawn from a glass preform 202, the preform 202 being suspended vertically at an upper end thereof. The preform is heated by a furnace 204 such that the lower end 206 of the preform 202 is sufficiently soft for a fibre strand 12a to be pulled therefrom. A drive unit 208 with counter rotating rollers 210 is provided for drawing the fibre 12 from the preform 202, the fibre 12 being received between the counter rotating rollers 210 such that counter rotation of the rollers applies a pulling force to the fibre 12. The width of the fibre is monitored optically by a monitoring unit 212. Signals from the monitoring unit 212 are received by a control unit 214, which control unit is connected to the drive unit 208. The control unit 214 monitors the width of the fibre strand 12a as the fibre 12 is being drawn, and is configured to execute a feedback algorithm to control the rate at which the fibre is pulled by the drive unit 208 such that the width of the fibre strand 12a of the fibre 12 remains substantially constant as the fibre is drawn. The control unit 214 may also be connected to the heating control of the furnace 204 in order to control the temperature of the preform 206 as it is being pulled, the preform temperature preferably being chosen in dependence on the rate at which the fibre is to be drawn. Thus, by controlling the draw rate and/or the temperature of the preform 206, it is possible to control the width of the drawn fibre strand 12a. To reduce the width of the fibre strand 12a, the draw rate will be increased, taking into account the temperature at the lower end 206 of the preform 202.

The preform 202 may be fabricated using one of a number of standard techniques, including Outside Vapour Deposition, Modified Chemical Vapour Deposition, and Plasma Vapour Deposition. The preform material will normally be made of silica glass (that is based upon silicon dioxide) which silica glass may have one or more dopants or other impurities added thereto such as germanium in order to control the refractive index of the resulting fibre strand. In the present example, the preform 202 has a central region 202a in which the silica glass contains germanium oxide (and/or titanium oxide and/or aluminium oxide) in order to raise the refractive index, whereas an outer region 202b of the preform 202 is substantially undoped or contains a dopant such as boron and/or fluorine such that the refractive index of the glass material in this outer region is less than that of the glass in the inner region 202a. Alternatively, the core may consist of substantially undoped silica with the cladding having added dopants which reduce its refractive index compared to that of the core. When drawn, this results in the fibre strand 12a having a central core region and a surrounding cladding region, the core region having a higher refractive index than the cladding region so that light can be retained in the core region.

It will be appreciated that the relative respective widths of the core and cladding regions of a fibre will depend on the relative respective widths of the inner and outer regions 202a, 202b of the preform. Therefore, in order to form a fibre with a reduced width but having a core region that is of the standard diameter for single mode propagation (normally about 8-9 microns), a non-standard preform will have to be fabricated in which the outer region 202b is proportionally of lesser width than the inner region 202a, as compared with conventional preform.

Soon after the glass strand 12a is drawn from the preform 202, the strand is coated by means of a coating unit 216, the coating unit being situated no more than a few metres below the point where the fibre is drawn to reduce the likelihood of dust or other damaging materials being deposited on the strand 12a before the protective coating is applied by the coating unit 216. In this example, the coating unit 216 is configured to apply a primary coating as well as a secondary coating, although only a single coating may be needed, for example a carbon-based hermetic coating of less than 1 micron. The secondary coating will generally contain a pigment for colour-coding the fibre, different pigments being used to provide different colouring to aid identification. Alternatively, a further coating may be applied to colour the fibre.

In order to reduce the effects of Polarisation Mode Dispersion, a drive mechanism 218 may be provided to rotate or spin the fibre in the axial (vertical) direction. Normally, this drive mechanism 218 will be situated about 10 metres below the furnace 204, the fibre being suspended under its own weight between the drive unit 210 and the drive mechanism 218. In order to reduce the likelihood that the fibre will break during spinning, the rate at which the fibre is fabricated may be reduced.

To produce an optical cable from one or more fibres 12, the cable apparatus of FIG. 10 may be employed. The cable apparatus 300 includes roller means 314, the roller means being configured to support and/or guide the fibres before they enter a resin coating stage 316, the resin coating stage having guide means 317 (when the cable is to have a plurality of fibres) for retaining the fibres 12 in the required positional relationship as the fibres travel through the coating stage 316 for coating. The coating stage 316 is configured to coat the fibres 12 with a buffer layer, the buffer layer being of resin material which is then cured with ultra violet radiation from, for example, a UV lamp. The fibres coated with a buffer layer enter a second coating stage 318 in which a jacket layer 3 is applied around the buffer layer at a jacket application stage 318a, and in which, at a microsphere coating unit 318b, glass microspheres are then applied to the outer surface of the cable jacket (which is at that stage uncured). An electrostatic device 319 is provided to charge the microspheres in order to improve their attraction to the cable jacket. In addition, positive pressure chambers 321, 331 are respectively positioned at the input and output of the microsphere coating unit 318b to reduce the likelihood of a particle leakage occurring. After the cable has been coated with microspheres, the cable 1 then passes into a UV curing unit 320 in order to cure the outer jacket formed from UV-curable resin.

FIGS. 11 and 12 show schematically an example of a second coating stage 318 in more detail. A jacket application stage 318a receives one or more fibres 12 surrounded by a common buffer layer 2, and applies a jacket layer 3 around the buffer layer, the jacket layer being formed from a UV-curable resin. The cable 1 then reaches a microsphere coating unit 318b, in which microsphere particles are applied to the exterior surface of the uncured resin jacket 3.

The microsphere coating unit 318b in this example has a main body member 402 having an inlet 404 for receiving a cable 1 to which microspheres are to be applied; a through passage 406 (which may be axial) through which portion of the cable extends as that portion is being coated (the path of the cable being indicated by the dotted line 1); and, an outlet 408 through which the cable exits the main body member 402.

A particle inlet 410 in communication with the through passage 406 is provided for introducing or injecting particles into the passage 406 so that the injected particles may impinge and thereby adhere upon the uncured outer surface 3 of the cable 1 as the cable travels through the passage 406.

A vessel or container 412 for holding particles to be injected is connected to the inlet 410. To inject the particles, pressurised air or nitrogen or other fluid is passed through the container 412 from a source 414 connected thereto. The air flow generated by the source 414 carries particles within the through passage 406 in an airborne fashion, such that a fluidised flow of particles within the through passage results. Particles which travel along the through passage 406 without adhering to the cable 1 exit through a discharge outlet 416, the discharge outlet being connected to a collection vessel 418 where the un-used particles collect. A pump 420 is provided in fluid communication with the collection vessel 418 to draw or at least retain the un-used particles therein.

In use, a flow of particles at least partially carried by the flow of gas generated by the source 414 enters the through passage 406, and flows at least in part along the surface of the cable portion transiently located in the passage 406. The cable 1 is drawn through the through passage 406, such that particles are distributed over the cable surface as the cable is drawn.

So that particles are distributed more evenly over the cable surface, the coating stage 318b is configured such that significant turbulence in the particle flow is generated. To cause or increase this turbulence, the inner surface 422 of the through passage 406 includes a plurality of axially spaced ribbed portions, each rib portion extending around the inner surface of the through passage so as to provide respective constrictions which disturb the flow of particles travelling along the through passage 406. When viewed in cross section, the rib portions preferably have a pointed tip to increase the turbulence, each rib portion being formed from oppositely inclined facets which meet along a circular line. In one embodiment, auxiliary passages 426 in communication at each respective end thereof with the through passage 406 are provided for guiding part of the fluid flow away from the through passage 406, and subsequently returning this flow into the through passage 406 in order to cause disturbance, at least in part due to the mixing between the returned flow or flows and the flow travelling along the through passage. In FIG. 12, the auxiliary passages 426 extend through the rib portions 424, such that mixing between the different flows occurs in the recess regions 430 formed between neighbouring rib portions.

Towards the inlet 404 and outlet 408 of the main body member 402, there are provided respective pressurised air sources 432, 434, for introducing pressurised air into the main body member 402 so as to reduce the likelihood of the respective outlet and inlet becoming blocked with particles 4, in this example glass microspheres.

An example of the apparatus generally described with respect to FIGS. 11 and 12 is more fully described in EP 757022.

FIG. 16 shows schematically a telecommunications installation 600 in which an optical cable 1 (which has a plurality of fibres each with a respective glass region of less than 100 microns in width) extends between two sites, situated at least 100 m apart, preferably 1 km apart. The cable allows communication between respective devices 604,606 located at each site. The cable 1 is located in a duct 608, and preferably has a textured outer surface, such that the cable when it was installed could have more easily been installed using a blowing technique.

Any appropriate particulate matter can be embedded in the coating in the microsphere coating unit 318b although preferably microspheres of solid glass and diameter between 10 and 120 μm are applied. The feed rate of the cable 1 is optimally 300 m/min. Throughout the present description like reference numerals refer to like parts.

A first alternative embodiment of the microsphere coating unit 318b is shown in FIGS. 17 to 19. The portion of the uncured resin coated cable 1 which is to have microspheres applied thereto is passed in direction A through a revolving drum configuration designated generally 30 comprising a lower revolution outer drum 32 which contains an inner drum 34 comprising a counter-rotating higher revolution revolving cylindrical mesh (or other sheet material having a surface with plurality of openings therein). The drums 32, 34 can be driven in any appropriate manner, and in the embodiment shown the outer drum 32 is tyre driven by direct engagement with motor 36 and the inner drum 34 is belt driven by motor 38. Alternatively the drums can be driven in the same direction of rotation.

The cable 1 passes though the passage defined by the inner drum 34. Microspheres (glass beads) are admitted into the revolving outer drum 32 from a hopper 40 with cam-controlled feed and are dispersed randomly throughout the volume of the drum configuration 30 by the revolving mesh 34 to provide an even distribution of microspheres. The mesh hole diameter is slightly larger than the bead diameter which, in the embodiment does not exceed 75 μm. Fins (not shown) on the inside surface of the outer drum 32 serve to re-animate any beads that settle out at the bottom of the outer drum 32. A proportion of the glass beads pass through the mesh of the inner drum 34 and are kept in suspension in the inner space by the revolution of the inner drum 34. A proportion of these adhere to the uncured resin coated surface of the cable 1. The coated fibre portion then passes through the UV curing unit 20 and is cured by curing lamps 42.

The drums 32,34 have controllable speed, and the hopper 40 has controllable feed such that the operation of the system can be easily controlled. For example a downstream sensor such an optical sensor (not shown) can detect the coating density or distribution of the microspheres and a control unit can vary the rotational speeds or other parameters accordingly to vary the density or distribution accordingly.

The system of the first alternative embodiment is particularly suitable for off-line operation but can be used as part of an on-line, fibre drawing stage where there are restrictions on the height of the drawing tower, by providing additional directional rollers to run the cable horizontally.

In the first alternative embodiment, because the microspheres are distributed by the mesh drum when they are fed into the outer chamber, they do not have to be fluidised before they enter the drum. Hence, particles can be introduced into the chamber as a flow in which the particles are in a settled state, bearing down on one another under the influence of gravity, the particles only being mixed with air or other gas once they enter the chamber. The distribution of particles on the surface of the cable 1 can be readily adjusted by changing the speed of the inner chamber and/or outer chamber, which can be used to provide a feedback-controlled coating system. The system is only useable in a horizontal orientation, but this facilitates its use as an off-line post-drawing technique.

However it also provides the capability for on-line coating where there is a restriction on the height of the drawing tower. Yet further, as no forced flow of air through the chamber is required, the system is relatively immune to blockage by microspheres. Furtherstill, because the system is not pressure dependent, it will work with the chamber pressure lower than the atmospheric pressure to provide protection against any leakage of the microspheres from the chamber. Preferably the outer chamber also revolves and is finned to redistribute microspheres in the apparatus. As a result microspheres only need to be added to the chamber to replenish those that have been applied to the cable. There is no requirement to provide any through flow system as a result of which the apparatus is relatively simple, requiring, in the embodiment, controlled feed for the glass bead hopper.

A second embodiment of the microsphere coating unit 318b is shown in FIGS. 20 to 24. The cable 1 is passed though a generally cylindrical chamber 50 which contains a fan 52 which distributes glass spheres throughout the volume of the chamber 50. The fan 52 is belt driven from motor 55 in the embodiment although any appropriate drive may be used. The fan provides one example of means for circulating a gas-particle or air-particle mixture within the chamber. The fan 52 preferably has constant pitch blades (uniform cross section) to give unequal air speeds across the diameter of the chamber 50 and hence provide turbulence in order to encourage mixing of the air within the chamber 50 and a uniform distribution of the beads. Glass beads are fed onto the fan 52 through a hopper 54 with cam controlled feed, and dispersed by the air movement. The cable 1 has an uncured layer of acrylate coating on its surface when it is passed through the chamber and the glass beads adhere to this surface; the coating is cured downstream as discussed above. Any glass beads settling out will be drawn in around the edge of the fan 52 and be redistributed.

Control of the fan speed can vary the distribution of glass beads in the chamber 50 and allow feedback control of the system to achieve desired coating density or uniformity as described above.

Because of the even distribution of the beads in the chamber 50, the cable 1 may pass in either direction in the vertical configuration shown in the variant of FIGS. 20, 21 and 24. Alternatively it can be horizontally oriented and pass in either direction as shown in FIGS. 22 and 23. In the horizontal orientation a baffle or plurality of baffles (not shown) is preferably provided inside the chamber 50 to compensate for any unevenness of distribution in this configuration, comprising for example annular fins angled to direct the beads towards the cable 1. Indeed similar baffles could be provided to enhance operation of the vertical orientation arrangement as well. The configuration of the second embodiment is suitable for both on-line and post-production bead coating, and the skilled person will recognise how to re-configure the apparatus in each instance.

Preferably an electrostatic gun 56 is provided in either orientation, as shown in FIG. 24, to electrostatically charge the beads and/or the cable portion, in order to increase the rate at which the beads attach to the cable 1. This would give this apparatus the means to achieve very high throughput rates.

Because of the provision of an impeller (circulating or other flow-generating means) (which in the second embodiment is a fan), glass beads do not have to be fluidised before entering the chamber. Furthermore, the impeller's speed (preferably the fan speed) can be readily and quickly be adjusted hence varying the distribution of the glass beads and allowing feedback control. Because the impeller provides an even distribution of the microspheres throughout the system, the system can be used with the cable oriented either vertically or horizontally. This makes it suitable for both on-line and post-production bead coating.

As there is a balanced flow of air within the chamber and no net flow driving the particles to a particular inlet or outlet, the system is relatively immune from blockage by particulate matter. Furthermore the system is not pressure based as a result of which it can be run with the chamber at a lower pressure than atmospheric pressure, reducing the risk of the leakage of glass beads.

A third embodiment of the microsphere coating unit 318b is shown in FIGS. 25 and 26. The uncured resin coated cable 1 is passed though a chamber 60 which contains a plurality of glass bead hoppers 62 with cam controlled feed. The hoppers 62 are distributed down the length of the chamber 60 to provide more even distribution of microspheres. A series of vibrating baffles 64 are positioned around the unit which serve to at least transiently support the beads, so as to deflect, distribute and animate the glass beads. The baffles comprise 12 generally semi-circular cascade shelves 66 which are staggered around and down the chamber 60 at 1500 intervals around a central space through which the cable 1 passes to ensure an even coating of the glass beads to the cable. Alternatively, the baffles may be in the form of a frusto-conical surface which surrounds the central space for the cable 1. The shelves 66 carry upstanding fins 67 which may be planar or in the embodiment shown curved around the cable 1. Vibration rings 68 are provided around the outer wall of the chamber 60 to vibrate the baffles 64 and can be driven by any appropriate vibration transducer as will be apparent to the skilled reader. The vibration aids the animation of the glass beads within the chamber 60.

Because of the provision of baffles, the microspheres do not have to be fluidised before entering the chamber. Furthermore the distribution of glass beads can be readily and quickly adjusted by adjusting the feed rate of the beads. Since the baffles vibrate, the distribution can be further controlled by varying the vibration amplitude of the plates allowing feedback control. Because of the provision of positive pressure chambers the system is readily protected from blockage by beads. The configuration ensures that there is a high level of assurance of even coverage of beads around the circumference of the cable. This assurance can be maintained regardless of the coating since it is unaffected by flow characteristics of moving air which are difficult to model and predict. The invention further offers the possibility of very high rates of throughput of fibre as the concentration of beads around the fibre can be controlled at high levels.

At the bottom of the chamber 60 there is a glass bead scavenging outlet 70 comprising a suction system to collect any beads that have not adhered to the surface of the cable 1. The chamber 60 has a positive pressure chamber 72, 74 top and bottom respectively to exclude unused beads.

The distribution of glass beads can be readily and quickly adjusted by adjusting the feed rate of the beads and the vibration amplitude of the baffles 64 allowing feedback control as discussed above.

A fourth embodiment of the microsphere coating unit 318b is shown in FIGS. 27 to 29. The uncured resin coated cable 1 is passed though a chamber 80 which contains one or more inlet ports 82 though which air carrying glass microspheres can enter the chamber 80 in the direction of arrow B. The unused air/bead mix exits the chamber at outlet 84. It is preferable to arrange the ports 82 such that a cyclone develops within the chamber 80 around the cable 1. It is also beneficial for the inlet and the outlet ports 82, 84 to be vertically and/or horizontally offset. Inherent clearance of the cable inlet and outlet ports can hence be achieved by the design of the chamber and the position of the outlet ports to ensure that beads do not settle and cause blockage.

The inlet port or ports 82 require the beads to be fluidised. This can be achieved by passing the inlet air flow over a bed which animates the beads either through vibration or by passing air through the bed. In the embodiment shown the air/bead mix is preferably formed in a duct 86 joining the inlet 82 and outlet 84 and carrying a circulatory pump fan 88 of any appropriate type upstream of a bead hopper 90 with cam controlled feed. Alternatively the jet can rely on the force created by an outlet suction pump or pumps, rather than pumping air into the inlet or inlets 82.

The chamber 80 preferably has a tapering cross section (such as conical) to cause the cyclone to change its angular velocity as it approaches the outlet port or ports 84. The chamber has positive pressure chambers top and bottom 92, 94 respectively at the cable inlet and outlet to exclude unused beads and an air bleed 96 running to a filter and allowing pressure control and bead recovery.

Because of the provision of an air jet in the fourth embodiment, rapid and even application of the beads can be obtained by optimisation of the airflow characteristics within the chamber. In the fourth embodiment the inlet and outlets are offset providing inherent clearance of the ports.

A fifth embodiment of the microsphere coating unit 318b is shown in FIGS. 30 to 32. The uncured resin coated cable 1 is passed through a cylindrical chamber 100 which contains a cylindrical fan 102. The cable 1 passes along the vertical central axis of rotation of the fan 102. The fan 102 is designed to draw bead-laden air towards the central axis, forming a vortex around the cable 1.

The bead-laden air enters the chamber 100 via a feed alcove 104 comprising an elongate chamber running down the side of the main chamber 100 and hence the length of the cylindrical fan 102 and communicating via an open space at the interface. The feed alcove is fed by ducting 106 to which beads are fed by a hopper 108 which has cam controlled feed. Air is driven along the ducting in the direction shown by arrow C by the action of the fan itself. An air bleed 110 runs from the duct 106 to a filter and allows pressure control and bead recovery. The chamber has positive pressure chambers top and bottom 112, 116 respectively at the cable inlet and outlet to exclude unused beads.

The cylindrical fan 102 is of the type known as a vortex fan and is driven via a belt from motor 118 although any appropriate drive can be adopted. It is mounted to annular seals and sealed bearings to isolate the chamber and comprises a plurality of longitudinally extending blades 120 of curved cross-section to drive the air/bead mix towards the centre of the chamber. The blades 120 are mounted to upper and lower annular plates to allow longitudinal passages at the centre of the fan 102 for the beads to pass through. A tube 122 is provided at the outlet end of the chamber 100 to protect the fibre from side impact or the air/bead mix.

Once again the operation of the apparatus can be controlled by varying the fan speed, providing good controllability and the possibility of feedback control as discussed above. The provision of a vortex fan also allows rapid and positive coating of the cable.

A sixth embodiment of the microsphere coating unit 318b is shown in FIGS. 33 to 35. The uncured resin coated cable 1 is passed in a horizontal orientation though a chamber 130 which is generally cuboid in shape and contains a bed 132 which provides a means to fluidise the beads such that a large number of beads are maintained in the volume of air over the bed 132. A hopper system 134 with cam-controlled feed delivers glass beads on to the surface of the bed 132. The chamber has positive pressure chambers 136, 138 at the cable inlet and outlet respectively to exclude unused beads and an air bleed 140 running to a filter and allowing pressure control and bead recovery.

Fluidisation of the glass beads may be achieved using a flow of air through the bed (not shown) or preferably by making the bed vibrate at an appropriate frequency and amplitude using externally mounted vibration transducers 142, which may be of any appropriate type as will be well know to the skilled reader. The bed preferably has an upwardly concave curved surface to improve the consistency of coverage of the cable with the glass beads, effectively focussing the beads on the fibre.

A feedback control system of the type described above regulates the flow of glass beads, allowing improved control over bead distribution readily and quickly by adjusting the feed rate of the beads and/or the vibration amplitude of the flat bed.

In the sixth embodiment, because the bed vibrates there is no requirement to fluidise the beads before they enter the chamber, and the distribution of glass beads can be readily and quickly adjusted by adjusting the feed rate of the beads and the vibration amplitude of the bed. As a result a feedback control can be implemented. The system is readily protected from blockage by beads and offers the possibility of very high rates of through-put since the concentration of beads around the fibre can be controlled at high levels.

A seventh embodiment of the microsphere coating unit 318b is shown in FIGS. 36 to 41. The uncured resin coated cable 1 is passed through a passage 150 which interconnects three chambers 152a,b, 154a,b, 156a,b. In the embodiment of FIGS. 36 to 38 the chambers 152a, 154a and 156a are generally conically shaped and tapering downwardly, joined together along their length with a vertical opening between the chambers through which the cable 1 passes. The passage 150 comprises a tubular passage or core tube.

Each of the chambers 152a,b, 154a,b, includes an inlet 158 which accepts a flow of beads and causes them to be swirled round inside the chamber. The swirling action results in beads being thrown out to the walls of the chamber and also into the passage 150 between the chambers.

In the embodiment shown in FIGS. 36 to 38 the flow of fluidised beads is injected into the conical chamber 152a, 154a, 156a in such a way as to cause a cyclone action within the chamber. Respective ducts 162a, 162b, 162c circulate air and beads from an outlet 164 in the chamber to the inlet 158. Provided on each duct 162a, 162b, 162c is a circulatory pump fan 166 which drives air around the duct. Downstream of the fan 166 is a glass bead hopper 168 with cam controlled feed. The passage 150 has positive pressure chambers 170, 172 at the cable inlet and outlet respectively to exclude unused beads and each duct 162 has an air bleed 174 running to a filter and allowing pressure control and bead recovery. This arrangement has the advantage of having no moving parts within the chambers

A variant on the seventh embodiment is shown in FIGS. 39 to 41. In this embodiment the chamber 152b, 154b, 156b effectively comprises the ducting itself and rotating brushes 176 are provided inside each of the chambers. This has the advantage of handling an input of beads that is not fluidised. The bristles of the brushes 176 disperse the beads throughout the chamber 152b, 154b, 156b and can also be arranged to flick the beads towards the cable 1 though suitable profiling of the chamber wall. It is advantageous to have the helical brushes 176 rotating in a direction which acts to keep the beads in the chamber, against the opposing forces of gravity and air flow.

A further alternative (not shown) is to install rotating slotted drums within each of the chambers. The slots would be arranged to push air and beads out towards the walls of the chamber. This approach has the advantage of providing a flow of air to assist in carrying the beads towards the cable.

In the seventh embodiment, because the fibre coating chamber is defined at an intersection of a plurality of chambers, rapid and positive coating of the cable is achieved. In a vortex or cyclone system, a simple and reliable apparatus is obtained. The system can be easily controlled either by varying the vortex speed and direction or the brush or drum speed, as well as the glass bead feed rate, to allow feed back control.

An eighth embodiment of the microsphere coating unit 318b is shown in FIG. 42. The cable 1 passes through a coating chamber 190, which comprises a generally cylindrical tube 191 (preferably made of glass) terminating at each end in a generally conical portion formed from a substantially solid block (199a and 199b) which each define a chamber having a frusto-conical surface (the generally conical portion 192 and 193). The cable 1 also passes through positive pressure chamber 72 located adjacent the first (upstream) end 192 of the passage and positive pressure chamber 74 located adjacent the second downstream) end 193 of the passage, the pressure within each pressure chamber 72,74 being above that at the respective end of the passage towards which that chamber is situated.

The tapering portion formed by the conical surface 192 may alternatively be curved in a radial direction relative to the axis of the tubular portion or the tube 191, such that the cross sectional area of the passage (formed by the frusto-conical surface at the upstream end, the tube and the frusto-conical surface 193 of the downstream end) presented to a flow entering the glass tube 191 decreases smoothly. This will help reduce turbulence within the tube 19.1, and allow more easily the possibility of a substantially laminar flow of the gas-particle mixture, at least within the tube 191, where coating of the cable with particles take place.

A mixture of air and microspheres is admitted into the coating chamber via two ducts or inlets 196 passing through block 199a and apertures 194a located in the frusto-conical surface 192. Although in the embodiment there are only two ducts and apertures, it is understood that the air and microsphere mixture may be admitted using a plurality of ducts/apertures entering either through the walls of the block 199a or alternatively directly into the tube 191 (as shown later in FIG. 43). The air and microsphere mixture is created either by fluidising the microspheres in a hopper (not shown) or mechanical metering method. The microspheres are then entrained with the flow of air which is pushed along ducts 196 and into the tube 191.

Preferably, the inlets 196 for the gas-particle mixture will be arranged to direct the mixture into the passage such that the mixture flows around the cable as the mixture is flowing along the passage. The mixture may thus have flow lines which follow a helical-like path around the cable. Alternatively or in addition, there may be provided guide means towards the upstream end of the passage (e.g. in the conical portion or frusto-conical portion) to direct the flow of mixture such that the mixture flows around the cable, at least as it travels along the tubular portion.

The air and microsphere mixture distributes through the tube 191, causing microspheres to contact and adhere to the uncured resin coated surface of the cable 1. The flow of air and entrained microspheres passes along the tube 191 and exits through scavenging outlet 195 which collects the unused microspheres which have not adhered to the cable 1. The collected air and microsphere mixture is recycled for later use by re-entry via ducts 196 and apertures 194a.

A filter membrane 197 extends across the entire cross-sectional area of the first end 192, except for an area through which positive pressure chamber 72 containing the cable 1 protrudes. Membrane 197 serves to prevent any microspheres from exiting the chamber through an air exit duct 198 which acts as a pressure relief by allowing air to leave the chamber as necessary as indicated by arrow A.

A vibration mechanism 200 is attached to the block 199a which encloses the top of the tube 191. Vibration mechanism 200 is used to cause small vibrations or agitations to permeate through the block and therefore supply localised vibrations to the section of the chamber enclosed by the block, which includes the top of the tube, together with the entry apertures 194a and membrane 197. The vibrations can help prevent the undesirable settling of some microspheres on surfaces, such as for example the frusto-conical surface 192, and enhances the flow of microspheres through tube 191 by preventing build up within the chamber defined by block 199a. The vibration mechanism 200 illustrated in FIG. 42 is air-driven although it is understood that any suitable vibrating or agitating means may be used.

The rate of flow of the air and microsphere mixture through ducts 196 is controllable, and thereby allows for feedback to change the density of the coating of microspheres on the cable 1. A downstream sensor (not shown) can detect the coating density and a control unit can vary the air and microsphere flow accordingly until the desired coating is achieved.

Positive pressure chambers 72 and 74 are for preventing microspheres from escaping from the chamber 190. In addition, a secondary extract duct 201 is provided as a safety device beyond each of the positive pressure chambers. Secondary extract ducts 201 operate using negative pressure to extract in the direction of the arrow marked B any microspheres if these have managed to pass through the positive pressure chambers and prevents them from escaping into the atmosphere.

A variation on the eighth embodiment is illustrated in FIG. 43, in which like numerals designate like features. In this variation, the air and microsphere mixture is admitted at staggered locations along the cylindrical portion of the tube 191, as indicated by ducts 196 and apertures 194b.

The eighth embodiment may further be enhanced by the provision of a plurality of baffles (not shown) within the tube 191, such as are described in relation to FIGS. 25 and 26. These baffles may be either fixed in position or moveable and serve to deflect the microspheres during their transport within the tube 191, thus enhancing the density and distribution of the microspheres adhering to the uncured resin coated cable surface.

Referring to FIG. 44, positive pressure chamber 72 is now described in more detail. The chamber comprises two elongate tubular portions 205 and 206, joined by inlet 207 through which pressurized air is introduced. Together these define a channel 208 of varying radius, through which the cable 1 may pass unhindered. Air flow entering the channel from the inlet 207 flows in both directions away from the inlet, with the larger proportion of the air flow occurring towards tube 191. The proportion of airflow in the different directions is influenced by the inner diameter differential D1>D2 between the two elongate tubular portions 205 and 206 as illustrated in the drawing (where D1 is the inner diameter of the tubular portion 205 closest to tube 191). Alternatively, or in addition, the length differential L1>L2 can be used to influence the proportions of airflow.

The operation of the positive pressure chamber 72 as described above generates a stream of gas into the tube 191 thereby substantially preventing microspheres from entering the pressure chamber 72 and escaping, and operates at a higher pressure than air which conveys microspheres within the fibre coating unit. It will be understood that a corresponding pressure chamber 74 at the opposite end of the coating chamber will operate in a similar manner. Furthermore, the gas stream into the tube 191 from a positive pressure chamber will advantageously assist in generating turbulence within the tube 191, particularly if there are positive pressure chambers 72, 74 provided at each end where the gas streams are in opposing directions.

In addition, the positive pressure chamber may be provided with secondary extract ducts (not shown in FIG. 44) as described with reference to FIG. 42 as an added security precaution to prevent microspheres from escaping into the atmosphere. These secondary extract ducts would be located to catch any microspheres which manage to pass through the positive pressure chamber, and would extract the microspheres using a duct having negative pressure.

It will be appreciated that aspects of the various embodiments described above can be combined together where appropriate, and that the invention can be implemented using suitable materials and apparatus as will be apparent to the skilled person.

In the fabrication methods described above, the particles are moving within a medium, such as air. However, the cable may be drawn through an ensemble of substantially still or quiescent particles, any movement of the particles being caused by movement of the cable and the particles which adhere to the cable surface.

A cable formed with a texture outer surface and where the glass regions are of reduced width can conveniently be installed in a duct using a blowing technique. Because such a cable accommodate an increased number of fibres due to the reduced glass diameter of these fibres, it will be possible to replace existing cables of a given fibre count with cables fabricated of a higher fibre count according to the invention. In many situations, this will reduce the need to replace existing ducts with larger ducts, thereby providing significant savings in improvement costs as the number of fibres to be installed in a duct increases.

Cables of more conventional construction, that is loose fibre or slotted core cables, with or without tensile load bearing members, can also be fabricated in accordance with the invention. In particular, so-called strength-denuded cables which are designed for use with cable blowing techniques and not for traditional pulled installation are suitable for fabrication according to the invention. The reduction in fibre diameter can give rise to useful savings in necessary cable size for a given fibre count or increase the fibre count for a given cable size. Smaller cables means that smaller ducts can be used, which can give rise to significant cost savings and other advantages.

Also, either conventional or blowing-specific cable designs can benefit from the invention in that when optical fibres are “broken out” from the cable, the lower permissible maximum bend radius means that the broken-out fibres can be housed and terminated using equipment where mandrels and other cable-management components can be significantly smaller and hence more compact. It will be appreciated that these benefits can be achieved even when the external surface of the cable is not specifically textured to give rise to increased viscous drag.

1. An optical cable having an optical fibre with a glass strand for channelling light along the cable, and a jacket disposed around the glass strand, the jacket having a textured outer surface for facilitating, under the influence of a fluid drag, the advancement of the optical cable along a conduit, wherein the glass strand has a width of less than 100 microns.

2. An optical cable as claimed in claim 1, wherein the or each glass strand has a width that is less than or equal to 80 microns in cross section.

3. An optical cable as claimed in claim 1, wherein the or each glass strand is formed from a silica glass material.

4. An optical cable as claimed in claim 1 wherein the textured outer surface of the jacket is due, at least in part, to the presence of particles in a material which provides the outer surface the jacket.

5. An optical cable as claimed in claim 4, wherein the particles are distributed about the outer surface of the jacket, at least some of the particles having a respective projecting portion which outwardly projects from the jacket.

6. An optical cable as claimed in claim 4, wherein the particles are of generally spherical shape.

7. An optical cable as claimed in claim 6 wherein the particles are glass.

8. An optical cable as claimed in claim 6, wherein the separation between the centres of the particles is on average, as measured along the axial direction of the cable, less than 350 microns, preferably less than 250 microns or 200 microns.

9. An optical cable as claimed in claim 1, wherein a buffer region is provided between the glass strand and the jacket, the buffer region being formed from a material having a lower elastic modulus than the average elastic modulus of the jacket.

10. An optical cable as claimed in claim 1, wherein the optical cable includes a plurality of glass strands for channelling light along the cable.

11. An optical cable as claimed in claim 1, wherein the or each glass strand has a protective region extending therearound, the protective region of the or each glass strand having an average thickness of less than 30 microns.

12. An optical cable as claimed in claim 1, wherein the optical cable has a plurality of glass strands, each having a generally circular cross section, and wherein the glass strands are arranged such that the respective centres of at least some neighbouring glass strands are within 130 microns of one another.

13. An optical cable as claimed in claim 12, wherein the respective centres of at least some neighbouring glass strands are within 100 microns of one another.

14. An optical cable as claimed in claim 1, wherein optical cable has a length in the axial direction of at least 50 metres.

15. An optical cable as claimed in claim 1, wherein the width of the or each glass strand is between 30 and 90 microns.

16. An optical cable as claimed in claim 13, wherein the width of the or each glass strand is between 55 and 85 microns.

17. An optical cable as claimed in claim 1, wherein the jacket is formed from resin material.

18. An optical cable as claimed in claim 7, wherein the buffer layer is formed from a material having a lower elastic modulus than the material of the jacket.

19. An optical transmission system including an optical cable as claimed in claim 1, and a conduit having the optical cable installed therein, wherein the optical cable is of a type that, during installation, can be caused to advance within the conduit by passing fluid therethrough.

20. A method of installing an optical cable within a conduit, wherein the optical cable is as claimed in claim 1, the method including the steps of: introducing a leading portion of the optical cable into the conduit;
and, passing fluid in a travel direction through at least part of the conduit to propel the cable along the conduit at least in part by fluid drag of the fluid passing over the cable at a relatively average flow velocity higher than the velocity at which the cable is propelled.

21. A method of fabricating an optical cable having a textured outer surface, including the steps of: receiving a cable portion, the cable portion having at least one optical fibre and a jacket disposed around the fibre; passing the cable portion through a medium having a plurality of particles therein; and, causing at least some of the particles to adhere to the cable jacket so as to provide the jacket with a textured outer surface, wherein the or each optical fibre has a glass region for channelling light along the cable and wherein the or each glass region has a width of less than 100 microns.

22. A method as claimed in claim 20, wherein the medium is a gaseous medium, and the particles are caused to move within the gaseous medium in an airborne fashion.

23. A method as claimed in claim 22, wherein the gaseous medium is caused to flow, the gaseous medium being mixed with the particles such that the cable is passed through a flow of gas-particle mixture.

24. A method as claimed in claim 23, wherein the flow of the gas-particle mixture is a turbulent flow.

25. A method as claimed in claim 22, wherein the cable portion is passed through a chamber containing a gas-particle mixture.

26. A method as claimed in claim 22, wherein the gas-particle mixture is formed by causing a gaseous current to flow over a bed of particles.

27. A method as claimed in claim 25, wherein the gas-particle mixture is introduced into the chamber at a chamber inlet.

28. A method as claimed in claim 25, including the step of advancing the cable portion and the gas-particle mixture along a passage having an axial portion that is elongate in an axial direction.

29. A method as claimed in claim 28, wherein the passage includes a chamber portion at least at one end of the axial portion, the chamber portion having a side wall that is inclined relative to the axial direction, such that the width of the chamber portion decreases with distance towards the axial portion, to a point where the width of the chamber portion matches the width of the axial portion.

30. A method as claimed in claim 29, wherein the chamber portion has a gas-particle inlet, the chamber portion being located at an upstream end of the axial portion, the method including the steps of: introducing the gas-particle mixture into the chamber portion through the gas-particle inlet; passing the gas-particle mixture from the chamber portion to the axial portion; and, introducing the cable portion into the axial portion of the passage.

31. A method as claimed in claim 30, wherein the chamber portion has a plurality of gas-particle inlets, the method including the step of introducing the gas-particle mixture into the chamber portion though the gas-particle inlets, such that the gas-particle mixture enters the chamber portion at different points distributed at intervals around the chamber portion.

32. A method as claimed claim 29, wherein the chamber portion is generally circular in a transverse cross section to the axial direction.

33. A method as claimed in claim 32, wherein the chamber portion includes a generally conical portion.

34. A method as claimed in claim 32, wherein the chamber portion has a side wall portion which is curved in a radial direction, such that the cross sectional area of the passage changes smoothly between the chamber portion and the axial portion.

35. A method as claimed in claim 28, wherein the axial portion is generally tubular.

36. A method as claimed in claim 28, wherein the passage has a plurality of constrictions spaced apart in the axial direction for constricting the flow of particles around the cable portion so as to cause or increase turbulence in the gas-particle flow.

37. A method as claimed claim 36, including the steps of separating a gas-particle flow into a plurality of component flows, and returning the component flows together so as to cause or increase turbulence in the gas-particle flow in the vicinity of the cable portion.

38. A method as claimed in claim 37, including the step of channelling a component flow around the or each constriction through a respective auxiliary passage.

39. A method as claimed in claim 20, including the steps of: at least transiently supporting particles on a moving surface; and, moving the cable portion past the moving surface, the moving surface being arranged such that movement of the surface causes particles to be dispersed towards the cable portion.

40. A method as claimed in claim 39, wherein the moving surface is inclined relative to the horizontal direction.

41. A method as claimed in claim 40, wherein the surface moves in a vibrational fashion.

42. A method as claimed in claim 40, wherein, the moving surface moves in a rotational fashion.

43. A method as claimed in claim 39, wherein the moving surface includes a plurality of openings dimensioned such that at least some of the particles can pass through the openings.

44. A method as claimed in claim 39, including the step of moving the cable portion past a plurality of moving surface portions, the surface portions being off-set relative to one another in a vertical direction, such that particles can move from one surface portion to another surface portion under the influence of gravity.

45. A method as claimed in claim 44, wherein the surface portions are arranged along a helical-like path, the helical-like path extending around the cable portion.

46. A method as claimed in claim 45, wherein the surface portions are formed from a plurality of radially extending resilient strands.

47. A method as claimed in claim 20, wherein a flow of gas is caused to circulate around the cable portion as the cable is being moved in a direction generally aligned with the axis of the cable.

48. A method as claimed in claim 47, wherein the cable is passed along the central axis of a chamber portion having rotational symmetry, and the gas is caused to move in a vortex-like fashion within the chamber.

49. A method as claimed in claim 30, wherein chamber portion has a cable inlet for introducing the cable portion into the chamber portion, and wherein the cable inlet includes an inlet chamber having an outlet in communication with the chamber portion, the method including the steps of passing the cable portion through the inlet chamber; and, feeding pressurised gas into the inlet chamber as the cable portion is being passed therethrough, so as to generate a positive pressure within the inlet chamber that is higher than that in the chamber portion.

50. A method as claimed in claim 49, wherein the inlet chamber has a entrance opening for receiving the cable portion and an exit opening through which the received cable portion can exit, and wherein at least the entrance opening or the exit opening are dimensioned relative to the cross section of the cable portion such that, in the absence of the positive pressure in the inlet chamber, at least some of the particles are sufficiently small to enter or exit the inlet chamber as the cable portion is being passed therethrough.

51. A method as claimed in claim 20, wherein the outer surface of the jacket of the received cable portion is adhesive such that at least some of the particles from the medium incident on the jacket surface are retained on the surface.

52. A method as claimed in claim 51, wherein the jacket is formed from a deformable material, such that at least some of the particles incident on the outer surface of the jacket become at least partially embedded in the jacket material.

53. A method as claimed in claim 52, including the subsequent step of causing the deformable material to harden with particles at least partially embedded therein.

54. A method as claimed in claim 52, wherein the deformable material is uncured resin material, the method including the step of hardening the resin material, the step of hardening the resin material being achieved through exposure to Ultra Violet radiation.

55. An optical cable having a plurality of optical fibres arranged in a side-to-side fashion relative to one another, each fibre having a respective glass region extending along the fibre, wherein the width of each glass region is less than 100 microns.

56. An optical cable as claimed in claim 55, wherein each glass region is in the form of a strand having a central axis, each strand being substantially circular in cross section to the central axis thereof, and wherein the cable includes a jacket, each optical fibre being arranged within the jacket such that the central axes of at least two neighbouring strands are within 100 microns of one another.

57. A telecommunications installation including a first site and a second site, the first and second sites being located at different geographical locations to one another, each site including a respective telecommunications device, the telecommunications installation further including an optical cable extending between the first site and the second site to allow optical communication between the sites, wherein the optical cable is as specified in claim 1.

58. A telecommunications installation as claimed in claim 56, wherein the first and second sites are separated by a distance of at least 100 metres.

59. A telecommunications installation as claimed in claim 57, wherein the separation between the sites is at least 1 km.

60. A method as claimed in claim 25, wherein the particles are mixed with a gaseous medium after being introduced into the chamber.

61. A method as claimed in claim 25, wherein the flow of gas-particle mixture is a substantially laminar flow.

62. A method as claimed in claim 47, wherein a flow of gas-particle mixture is caused to move along a passage and to circulate around the cable portion as the cable portion and the gas-particle mixture move along the passage
